(19) United States
(12) Patent Application Publication
(10) Pub. No.: US 2023/0179370 A1
(43) Pub. Date: Jun. 8, 2023

(54) UPLINK TRACKING REFERENCE SIGNAL TECHNIQUES IN WIRELESS COMMUNICATIONS

(71) Applicants: Runxin WANG, San Diego (JP); Muhammad Sayed Khairy ABDELGHAFFAR, San Diego, CA (US); Yu ZHANG, San Diego, CA (US); Krishna Kiran MUKKAVILLLI, San Diego, CA (US); Hwan Joon KWON, San Diego, CA (US); QUALCOMM INCORPORATED, San Diego, CA (US)

(72) Inventors: Runxin WANG, San Diego, CA (US); Muhammad Sayed Khairy ABDELGHAFFAR, San Jose, CA (US); Yu ZHANG, San Diego, CA (US); Krishna Kiran MUKKAVILLI, San Diego, CA (US); Hwan Joon KWON, San Diego, CA (US)

(21) Appl. No.: 17/999,747

(22) PCT Filed: Jul. 18, 2020
(86) PCT No.: PCT/CN2020/102883

§ 371 Date: Nov. 23, 2022

(51) Int. Cl. H04L 5/00

(52) U.S. Cl. CPC H04L 5/0051; H04L 5/0094

(57) ABSTRACT

Methods, systems, and devices for wireless communications are described for configuration and transmission of one or more uplink reference signals for tracking. A user equipment (UE) may transmit one or more uplink reference signals for tracking and a base station or transmission-reception point (TRP) may estimate one or more frequency or time shifts (e.g., a Doppler shift, time shift, or both) associated with communications with the UE. The estimated frequency shifts, time shifts, or combinations thereof, may be used to provide compensated communications (e.g., Doppler compensated communications) with the UE. The uplink reference signal for tracking may be a sounding reference signal that is configured as a tracking reference signal.

### CROSS REFERENCE

The present Application is a 371 national stage filing of International PCT Application No. PCT/CN2020/102883 by WANG et al. entitled “UPLINK TRACKING REFERENCE SIGNAL TECHNIQUES IN WIRELESS COMMUNICATIONS,” filed Jul. 18, 2020, which is assigned to the assignee hereof, and which is expressly incorporated by reference in its entirety herein.

### FIELD OF TECHNOLOGY

The following relates generally to wireless communications and more specifically to uplink tracking reference signal techniques in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support uplink tracking reference signal techniques in wireless communications. Various aspects of the described techniques provide for configuration and transmission of one or more uplink reference signals for tracking. A user equipment (UE) may transmit one or more uplink reference signals for tracking and a base station or transmission-reception point (TRP) may estimate one or more frequency or time shifts (e.g., a Doppler shift, time shift, or both) associated with communications with the UE. The estimated frequency shifts, time shifts, or combinations thereof, may be used to provide compensated communications (e.g., Doppler compensated communications) with the UE.

In some cases, a sounding reference signal (SRS) may be configured as the uplink reference signal and provide an uplink tracking reference signal (TRS). In some cases, radio resource control (RRC) signaling that configures a SRS may provide an enumerated usage of the SRS as for TRS, or an RRC parameter may be provided that indicates that a SRS of a different enumerated usage is also configured for TRS. In some cases, one or more reference signal resources may be configured to provide a signal suitable for TRS, such as time domain resources, frequency domain resources, spatial domain resources, or combinations thereof. In some cases, uplink reference signals for tracking (e.g., SRS configured for TRS) may be periodically transmitted, and may be activated or deactivated via RRC signaling, a medium access control (MAC) control element (CE), downlink control information (DCI), or any combinations thereof. In some cases, such reference signals may be aperiodic and triggered by, for example, a DCI or group common DCI. In some cases, a UE may provide a capability indication to a TRP that indicates whether the UE is capable of configuring an uplink reference signal for tracking. Responsive to the capability indication, one or more TRPs may transmit configuration information to the UE to configure one or more uplink reference signals for tracking.

A method of wireless communication at a UE is described. The method may include receiving, from a first transmission-reception point, control information that provides an indication that a first uplink reference signal is to be transmitted from the UE to provide one or more of frequency tracking or time tracking for uplink transmissions between the UE and one or more transmission-reception points, selecting, based on the indication, a reference signal configuration for the first uplink reference signal from a set of available reference signal configurations, and transmitting the first uplink reference signal based on the reference signal configuration.

An apparatus for wireless communication at a UE is described. The apparatus may include a processor, memory coupled with the processor, and instructions stored in the memory. The instructions may be executable by the processor to cause the apparatus to receive, from a first transmission-reception point, control information that provides an indication that a first uplink reference signal is to be transmitted from the UE to provide one or more of frequency tracking or time tracking for uplink transmissions between the UE and one or more transmission-reception points, select, based on the indication, a reference signal configuration for the first uplink reference signal from a set of available reference signal configurations, and transmit the first uplink reference signal based on the reference signal configuration.

Another apparatus for wireless communication at a UE is described. The apparatus may include means for receiving, from a first transmission-reception point, control information that provides an indication that a first uplink reference signal is to be transmitted from the UE to provide one or more of frequency tracking or time tracking for uplink transmissions between the UE and one or more transmission-reception points, selecting, based on the indication, a reference signal configuration for the first uplink reference signal from a set of available reference signal configurations, and transmitting the first uplink reference signal based on the reference signal configuration.

A non-transitory computer-readable medium storing code for wireless communication at a UE is described. The code may include instructions executable by a processor to receive, from a first transmission-reception point, control information that provides an indication that a first uplink reference signal is to be transmitted from the UE to provide one or more of frequency tracking or time tracking for uplink transmissions between the UE and one or more transmission-reception points, select, based on the indication, a reference signal configuration for the first uplink reference signal from a set of available reference signal configurations, and transmit the first uplink reference signal based on the reference signal configuration.

In some examples of the method, apparatuses, and non-transitory computer-readable medium described herein, the receiving the control information further may include operations, features, means, or instructions for receiving a usage indication that indicates a sounding reference signal is to be used as an uplink tracking reference signal. In some examples of the method, apparatuses, and non-transitory computer-readable medium described herein, the usage indication may be provided as an enumerated usage in a radio resource configuration parameter for a sounding reference signal resource set. In some examples of the method, apparatuses, and non-transitory computer-readable medium described herein, the sounding reference signal resource set having the enumerated usage indication for the uplink tracking reference signal may be configured only for uplink tracking reference signal usage.

In some examples of the method, apparatuses, and non-transitory computer-readable medium described herein, the usage indication may be provided as a separate radio resource configuration parameter for a sounding reference signal resource set that has a different enumerated usage. In some examples of the method, apparatuses, and non-transitory computer-readable medium described herein, the different enumerated usage for the sounding reference signal includes one or more of a usage for antenna switching, codebook-based precoding measurements, non-codebook-based precoding measurements, or beam management.

Some examples of the method, apparatuses, and non-transitory computer-readable medium described herein may further include operations, features, means, or instructions for receiving configuration information for the first uplink reference signal that configures one or more of time resources or frequency resources of a sounding reference signal resource set for uplink tracking. Some examples of the method, apparatuses, and non-transitory computer-readable medium described herein may further include operations, features, means, or instructions for transmitting, prior to the receiving the control information, a capability indication to the first transmission-reception point that indicates a UE capability to use a sounding reference signal for uplink tracking.

A method of wireless communication at a UE is described. The method may include receiving, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points, configuring at least a first sounding reference signal resource set for uplink tracking based on the configuration information, and transmitting a first sounding reference signal based on the first sounding reference signal resource set.

An apparatus for wireless communication at a UE is described. The apparatus may include a processor, memory coupled with the processor, and instructions stored in the memory. The instructions may be executable by the processor to cause the apparatus to receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points, configure at least a first sounding reference signal resource set for uplink tracking based on the configuration information, and transmit a first sounding reference signal based on the first sounding reference signal resource set.

Another apparatus for wireless communication at a UE is described. The apparatus may include means for receiving, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points, configuring at least a first sounding reference signal resource set for uplink tracking based on the configuration information, and transmitting a first sounding reference signal based on the first sounding reference signal resource set.

A non-transitory computer-readable medium storing code for wireless communication at a UE is described. The code may include instructions executable by a processor to receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points, configure at least a first sounding reference signal resource set for uplink tracking based on the configuration information, and transmit a first sounding reference signal based on the first sounding reference signal resource set.

In some examples of the method, apparatuses, and non-transitory computer-readable medium described herein, the configuration information includes one or more of a time domain configuration, a frequency domain configuration, a spatial domain configuration, a power configuration, a periodicity configuration, an activation command configuration, a transmission configuration, or any combinations thereof, for the first sounding reference signal resource set. In some examples of the method, apparatuses, and non-transitory computer-readable medium described herein, the time domain configuration provides at least two time domain resources for transmission of the first sounding reference signal within the first sounding reference signal resource set. In some examples of the method, apparatuses, and non-transitory computer-readable medium described herein, the time domain configuration provides at least two sounding reference signal resource sets in two or more consecutive uplink slots.

In some examples of the method, apparatuses, and non-transitory computer-readable medium described herein, the time domain configuration provides at least two time domain resources for transmission of the first sounding reference signal with a two or a four symbol time domain gap, the time domain configuration provides separate configurations for a low-band frequency range and a high-band frequency range, or any combinations thereof. In some examples of the method, apparatuses, and non-transitory computer-readable medium described herein, the frequency domain configuration indicates that a same fixed subcarrier comb pattern may be used across a set of time domain resources for transmitting the first sounding reference signal. In some examples of the method, apparatuses, and non-transitory computer-readable medium described herein, the spatial domain configuration indicates that the first sounding reference signal is transmitted using a single antenna port. In some examples of the method, apparatuses, and non-transitory computer-readable medium described herein, the power configuration indicates that the first sounding reference signal is transmitted at a same transmit power across all sounding reference signal resources of the first sounding reference signal resource set. In some examples of the method, apparatuses, and non-transitory computer-readable medium described herein, the periodicity configuration indicates a fixed periodicity for a set of transmissions of the first sounding reference signal.

In some examples of the method, apparatuses, and non-transitory computer-readable medium described herein, the set of transmissions of the first sounding reference signal may be configured with a same periodicity, a same frequency bandwidth, and a same set of subcarrier locations. In some examples of the method, apparatuses, and non-transitory computer-readable medium described herein, the set of transmissions of the first sounding reference signal is activated by a medium access control (MAC) control element.

In some examples of the method, apparatuses, and non-transitory computer-readable medium described herein, the first sounding reference signal may be transmitted aperiodically in response to a trigger received at the UE. In some examples of the method, apparatuses, and non-transitory computer-readable medium described herein, the trigger may be received in one or more of a DCI communication for the UE or in a group common DCI for a set of UEs.

In some examples of the method, apparatuses, and non-transitory computer-readable medium described herein, the activation command configuration provides an activation, deactivation, or triggering of the first sounding reference signal resource set based on a sounding reference signal activation command. In some examples of the method, apparatuses, and non-transitory computer-readable medium described herein, the transmission configuration indicates that the first sounding reference signal is to be transmitted without an uplink carrier frequency correction.

Some examples of the method, apparatuses, and non-transitory computer-readable medium described herein may further include operations, features, means, or instructions for receiving, from the first transmission-reception point, control information that provides an indication that the first uplink reference signal is to be transmitted from the UE to one or more transmission-reception points. Some examples of the method, apparatuses, and non-transitory computer-readable medium described herein may further include operations, features, means, or instructions for transmitting, prior to the receiving the configuration information, a capability indication to the first transmission-reception point that indicates a UE capability to use a sounding reference signal for uplink tracking.

A method of wireless communication at a UE is described. The method may include transmitting an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points, receiving, from the first transmission-reception point responsive to the uplink tracking capability indication, configuration information for at least a first sounding reference signal resource set that configures a first uplink sounding reference signal for uplink tracking, and transmitting the first uplink sounding reference signal to one or more transmission-reception points based on the configuration information.

An apparatus for wireless communication at a UE is described. The apparatus may include a processor, memory coupled with the processor, and instructions stored in the memory. The instructions may be executable by the processor to cause the apparatus to transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points, receive, from the first transmission-reception point responsive to the uplink tracking capability indication, configuration information for at least a first sounding reference signal resource set that configures a first uplink sounding reference signal for uplink tracking, and transmit the first uplink sounding reference signal to one or more transmission-reception points based on the configuration information.

Another apparatus for wireless communication at a UE is described. The apparatus may include means for transmitting an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points, receiving, from the first transmission-reception point responsive to the uplink tracking capability indication, configuration information for at least a first sounding reference signal resource set that configures a first uplink sounding reference signal for uplink tracking, and transmitting the first uplink sounding reference signal to one or more transmission-reception points based on the configuration information.

A non-transitory computer-readable medium storing code for wireless communication at a UE is described. The code may include instructions executable by a processor to transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points, receive, from the first transmission-reception point responsive to the uplink tracking capability indication, configuration information for at least a first sounding reference signal resource set that configures a first uplink sounding reference signal for uplink tracking, and transmit the first uplink sounding reference signal to one or more transmission-reception points based on the configuration information.

In some examples of the method, apparatuses, and non-transitory computer-readable medium described herein, the uplink tracking capability indication may be transmitted to the first transmission-reception point in radio resource control signaling during a connection establishment procedure for the UE. Some examples of the method, apparatuses, and non-transitory computer-readable medium described herein may further include operations, features, means, or instructions for receiving, from the first transmission-reception point, control information that provides an indication that the first uplink reference signal is to be transmitted from the UE to one or more transmission-reception points. Some examples of the method, apparatuses, and non-transitory computer-readable medium described herein may further include operations, features, means, or instructions for receiving configuration information for the first uplink reference signal that configures one or more of time resources or frequency resources of the first sounding reference signal resource set for uplink tracking.

A method of wireless communication at a transmission-reception point is described. The method may include transmitting, to a UE, control information that provides an indication that a first uplink reference signal is to be transmitted from the UE to provide one or more of frequency tracking or time tracking for uplink transmissions between the UE and one or more transmission-reception points, monitoring, based on the indication, for the first uplink reference signal, and calculating one or more of a frequency shift or a time shift associated with uplink transmissions from the UE based on the first uplink reference signal.

An apparatus for wireless communication at a transmission-reception point is described. The apparatus may include a processor, memory coupled with the processor, and instructions stored in the memory. The instructions may be executable by the processor to cause the apparatus to transmit, to a UE, control information that provides an indication that a first uplink reference signal is to be transmitted from the UE to provide one or more of frequency tracking or time tracking for uplink transmissions between the UE and one or more transmission-reception points, monitor, based on the indication, for the first uplink reference signal, and calculate one or more of a frequency shift or a time shift associated with uplink transmissions from the UE based on the first uplink reference signal.

Another apparatus for wireless communication at a transmission-reception point is described. The apparatus may include means for transmitting, to a UE, control information that provides an indication that a first uplink reference signal is to be transmitted from the UE to provide one or more of frequency tracking or time tracking for uplink transmissions between the UE and one or more transmission-reception points, monitoring, based on the indication, for the first uplink reference signal, and calculating one or more of a frequency shift or a time shift associated with uplink transmissions from the UE based on the first uplink reference signal.

A non-transitory computer-readable medium storing code for wireless communication at a transmission-reception point is described. The code may include instructions executable by a processor to transmit, to a UE, control information that provides an indication that a first uplink reference signal is to be transmitted from the UE to provide one or more of frequency tracking or time tracking for uplink transmissions between the UE and one or more transmission-reception points, monitor, based on the indication, for the first uplink reference signal, and calculate one or more of a frequency shift or a time shift associated with uplink transmissions from the UE based on the first uplink reference signal.

In some examples of the method, apparatuses, and non-transitory computer-readable medium described herein, the transmitting the control information further may include operations, features, means, or instructions for transmitting a usage indication that indicates a sounding reference signal is to be used as an uplink tracking reference signal. In some examples of the method, apparatuses, and non-transitory computer-readable medium described herein, the usage indication may be provided as an enumerated usage in a radio resource configuration parameter for a sounding reference signal resource set. In some examples of the method, apparatuses, and non-transitory computer-readable medium described herein, the sounding reference signal resource set having the enumerated usage indication for the uplink tracking reference signal may be configured only for uplink tracking reference signal usage.

In some examples of the method, apparatuses, and non-transitory computer-readable medium described herein, the usage indication may be provided as a separate radio resource configuration parameter for a sounding reference signal resource set that has a different enumerated usage. In some examples of the method, apparatuses, and non-transitory computer-readable medium described herein, the different enumerated usage for the sounding reference signal includes one or more of a usage for antenna switching, codebook-based precoding measurements, non-codebook-based precoding measurements, or beam management.

Some examples of the method, apparatuses, and non-transitory computer-readable medium described herein may further include operations, features, means, or instructions for transmitting configuration information to the UE for the first uplink reference signal that configures one or more of time resources or frequency resources of a sounding reference signal resource set for uplink tracking. Some examples of the method, apparatuses, and non-transitory computer-readable medium described herein may further include operations, features, means, or instructions for receiving, prior to the transmitting the control information, a capability indication from the UE that indicates a UE capability to use a sounding reference signal for uplink tracking.

A method of wireless communication at a transmission-reception point is described. The method may include transmitting, to a UE, configuration information for a sounding reference signal resource set that configures an uplink sounding reference signal for uplink tracking of one or more of frequency shifts or time shifts associated with uplink transmissions between the UE and one or more transmission-reception points, monitoring, based on the configuration information, for a first sounding reference signal, and calculating one or more of a frequency shift or a time shift associated with uplink transmissions from the UE based on the first sounding reference signal.

An apparatus for wireless communication at a transmission-reception point is described. The apparatus may include a processor, memory coupled with the processor, and instructions stored in the memory. The instructions may be executable by the processor to cause the apparatus to transmit, to a UE, configuration information for a sounding reference signal resource set that configures an uplink sounding reference signal for uplink tracking of one or more of frequency shifts or time shifts associated with uplink transmissions between the UE and one or more transmission-reception points, monitor, based on the configuration information, for a first sounding reference signal, and calculate one or more of a frequency shift or a time shift associated with uplink transmissions from the UE based on the first sounding reference signal.

Another apparatus for wireless communication at a transmission-reception point is described. The apparatus may include means for transmitting, to a UE, configuration information for a sounding reference signal resource set that configures an uplink sounding reference signal for uplink tracking of one or more of frequency shifts or time shifts associated with uplink transmissions between the UE and one or more transmission-reception points, monitoring, based on the configuration information, for a first sounding reference signal, and calculating one or more of a frequency shift or a time shift associated with uplink transmissions from the UE based on the first sounding reference signal.

A non-transitory computer-readable medium storing code for wireless communication at a transmission-reception point is described. The code may include instructions executable by a processor to transmit, to a UE, configuration information for a sounding reference signal resource set that configures an uplink sounding reference signal for uplink tracking of one or more of frequency shifts or time shifts associated with uplink transmissions between the UE and one or more transmission-reception points, monitor, based on the configuration information, for a first sounding reference signal, and calculate one or more of a frequency shift or a time shift associated with uplink transmissions from the UE based on the first sounding reference signal.

In some examples of the method, apparatuses, and non-transitory computer-readable medium described herein, the configuration information includes one or more of a time domain configuration, a frequency domain configuration, a spatial domain configuration, a power configuration, a periodicity configuration, an activation command configuration, a transmission configuration, or any combinations thereof, for the sounding reference signal resource set. In some examples of the method, apparatuses, and non-transitory computer-readable medium described herein, the time domain configuration provides at least two time domain resources for transmission of the first sounding reference signal within the sounding reference signal resource set. In some examples of the method, apparatuses, and non-transitory computer-readable medium described herein, the time domain configuration provides at least two sounding reference signal resource sets in two or more consecutive uplink slots. In some examples of the method, apparatuses, and non-transitory computer-readable medium described herein, the time domain configuration provides at least two time domain resources for transmission of the first sounding reference signal with a two or a four symbol time domain gap, the time domain configuration provides separate configurations for a low-band frequency range and a high-band frequency range, or any combinations thereof.

In some examples of the method, apparatuses, and non-transitory computer-readable medium described herein, the frequency domain configuration indicates that a same fixed subcarrier comb pattern is used across a set of time domain resources for transmitting the first sounding reference signal. In some examples of the method, apparatuses, and non-transitory computer-readable medium described herein, the spatial domain configuration indicates that the first sounding reference signal is transmitted using a single antenna port. In some examples of the method, apparatuses, and non-transitory computer-readable medium described herein, the power configuration indicates that the first sounding reference signal is transmitted at a same transmit power across all sounding reference signal resources of the sounding reference signal resource set.

In some examples of the method, apparatuses, and non-transitory computer-readable medium described herein, the periodicity configuration indicates a fixed periodicity for a set of transmissions of the first sounding reference signal. In some examples of the method, apparatuses, and non-transitory computer-readable medium described herein, the set of transmissions of the first sounding reference signal may be configured with a same periodicity, a same frequency bandwidth, and a same set of subcarrier locations.

In some examples of the method, apparatuses, and non-transitory computer-readable medium described herein, the set of transmissions of the first sounding reference signal may be activated by a medium access control (MAC) control element. In some examples of the method, apparatuses, and non-transitory computer-readable medium described herein, the first sounding reference signal may be transmitted aperiodically in response to a trigger received at the UE. In some examples of the method, apparatuses, and non-transitory computer-readable medium described herein, the trigger may be received in one or more of a DCI communication for the UE or in a group common DCI for a set of UEs. In some examples of the method, apparatuses, and non-transitory computer-readable medium described herein, the activation command configuration provides an activation, deactivation, or triggering of the sounding reference signal resource set based on a sounding reference signal activation command. In some examples of the method, apparatuses, and non-transitory computer-readable medium described herein, the transmission configuration indicates that the first sounding reference signal is to be transmitted without an uplink carrier frequency correction.

Some examples of the method, apparatuses, and non-transitory computer-readable medium described herein may further include operations, features, means, or instructions for transmitting, to the UE, control information that provides an indication that the first uplink reference signal is to be transmitted from the UE to one or more transmission-reception points. Some examples of the method, apparatuses, and non-transitory computer-readable medium described herein may further include operations, features, means, or instructions for receiving, prior to the transmitting the configuration information, a capability indication from the UE that indicates a capability to use a sounding reference signal for uplink tracking.

A method of wireless communication at a transmission-reception point is described. The method may include receiving, from a UE, an uplink tracking capability indication that signals one or more capabilities of the UE for using a sounding reference signal as an uplink tracking reference signal for one or more of frequency tracking or time tracking for uplink transmissions from the UE, transmitting to the UE, responsive to the uplink tracking capability indication, configuration information for at least a first sounding reference signal resource set that configures a first uplink sounding reference signal for uplink tracking, and receiving the first uplink sounding reference signal from the UE based on the configuration information.

An apparatus for wireless communication at a transmission-reception point is described. The apparatus may include a processor, memory coupled with the processor, and instructions stored in the memory. The instructions may be executable by the processor to cause the apparatus to receive, from a UE, an uplink tracking capability indication that signals one or more capabilities of the UE for using a sounding reference signal as an uplink tracking reference signal for one or more of frequency tracking or time tracking for uplink transmissions from the UE, transmit to the UE, responsive to the uplink tracking capability indication, configuration information for at least a first sounding reference signal resource set that configures a first uplink sounding reference signal for uplink tracking, and receive the first uplink sounding reference signal from the UE based on the configuration information.

Another apparatus for wireless communication at a transmission-reception point is described. The apparatus may include means for receiving, from a UE, an uplink tracking capability indication that signals one or more capabilities of the UE for using a sounding reference signal as an uplink tracking reference signal for one or more of frequency tracking or time tracking for uplink transmissions from the UE, transmitting to the UE, responsive to the uplink tracking capability indication, configuration information for at least a first sounding reference signal resource set that configures a first uplink sounding reference signal for uplink tracking, and receiving the first uplink sounding reference signal from the UE based on the configuration information.

A non-transitory computer-readable medium storing code for wireless communication at a transmission-reception point is described. The code may include instructions executable by a processor to receive, from a UE, an uplink tracking capability indication that signals one or more capabilities of the UE for using a sounding reference signal as an uplink tracking reference signal for one or more of frequency tracking or time tracking for uplink transmissions from the UE, transmit to the UE, responsive to the uplink tracking capability indication, configuration information for at least a first sounding reference signal resource set that configures a first uplink sounding reference signal for uplink tracking, and receive the first uplink sounding reference signal from the UE based on the configuration information.

In some examples of the method, apparatuses, and non-transitory computer-readable medium described herein, the uplink tracking capability indication may be received in radio resource control signaling during a connection establishment procedure for the UE. Some examples of the method, apparatuses, and non-transitory computer-readable medium described herein may further include operations, features, means, or instructions for transmitting, to the UE, control information that provides an indication that the first uplink reference signal is to be transmitted from the UE to one or more transmission-reception points. Some examples of the method, apparatuses, and non-transitory computer-readable medium described herein may further include operations, features, means, or instructions for transmitting, to the UE, configuration information for the first uplink reference signal that configures one or more of time resources or frequency resources of the first sounding reference signal resource set for uplink tracking.

### BRIEF DESCRIPTION OF THE DRAWINGS

FIG. 1 illustrates an example of a system for wireless communications that supports uplink tracking reference signal techniques in wireless communications in accordance with aspects of the present disclosure.

FIG. 2 illustrates an example of a wireless communications system that supports uplink tracking reference signal techniques in wireless communications in accordance with aspects of the present disclosure.

FIG. 3 illustrates an example of a SRS configurations that supports uplink tracking reference signal techniques in wireless communications in accordance with aspects of the present disclosure.

FIG. 4 illustrates an example of a reference signal resources that supports uplink tracking reference signal techniques in wireless communications in accordance with aspects of the present disclosure.

FIG. 5 illustrates an example of a process flow that supports uplink tracking reference signal techniques in wireless communications in accordance with aspects of the present disclosure.

FIGS. 6 and 7 show block diagrams of devices that support uplink tracking reference signal techniques in wireless communications in accordance with aspects of the present disclosure.

FIG. 8 shows a block diagram of a communications manager that supports uplink tracking reference signal techniques in wireless communications in accordance with aspects of the present disclosure.

FIG. 9 shows a diagram of a system including a device that supports uplink tracking reference signal techniques in wireless communications in accordance with aspects of the present disclosure.

FIGS. 10 and 11 show block diagrams of devices that support uplink tracking reference signal techniques in wireless communications in accordance with aspects of the present disclosure.

FIG. 12 shows a block diagram of a communications manager that supports uplink tracking reference signal techniques in wireless communications in accordance with aspects of the present disclosure.

FIG. 13 shows a diagram of a system including a device that supports uplink tracking reference signal techniques in wireless communications in accordance with aspects of the present disclosure.

FIGS. 14 through 22 show flowcharts illustrating methods that support uplink tracking reference signal techniques in wireless communications in accordance with aspects of the present disclosure.

### DETAILED DESCRIPTION

In some wireless communications systems, a user equipment (UE) may support communications with one or multiple transmission reception points (TRPs) (e.g., in a multi-TRP configuration). For example, the wireless communications system may include a cell associated with multiple TRPs, in which a UE may communicate with the cell by one or more than one TRP. Additionally or alternatively, the wireless communications system may include a cell associated with multiple remote radio heads (RRHs), where the UE may communicate with a TRP by one or multiple RRHs. The UE may also transmit uplink communications to one or multiple TRPs. Further, the UE may be moving with respect to one or more of the TRPs, and thus communications between the UE and the TRP(s) may by associated with Doppler shifts or Doppler spreads. In some cases, the Doppler effects on communications between a UE and different TRPs may not be consistent from one TRP to another TRP. That is, communications between the UE and a first TRP may experience a larger Doppler shift than communications between the UE and a second TRP. In some cases, the variable Doppler effects on communications between the UE and the multiple TRPs may degrade communications (e.g., decrease a reliability of the communications) between the UE and the multiple TRPs.

In some cases, a UE or TRP may perform Doppler pre-compensation in which a center frequency (e.g., XO) of a communication may be adjusted such that the communications are received at the receiving device with relatively little or no frequency shift. In order to determine an amount of Doppler pre-compensation that is to be used for a communication, a UE or TRP may estimate a Doppler effect (e.g., an estimated Doppler shift, an estimated maximum Doppler spread) based on a reference signal for tracking. For example, a UE may receive a reference signal (e.g., a tracking reference signal (TRS), a synchronization signal block (SSB) transmission, a channel state information-reference signal (CSI-RS)) from one or multiple TRPs and estimate aspects of a channel (e.g., a Doppler shift, a Doppler spread) between each of the TRPs and UE. This estimation may then be used for Doppler pre-compensation, time compensation, or both, for communications between the UE and one or more TRPs. However, existing uplink reference signals (e.g., sounding reference signals (SRSs)) transmitted from a UE to a TRP may not be suitable to provide a reference signal for tracking that can be used for Doppler effect estimations. In particular, in cases where UEs travel at relatively high speeds relative to a TRP, such as in high speed train (HST) situations, existing SRS may be insufficient to provide for time/frequency tracking, due to insufficient numbers of SRS instances, insufficient spread of SRS instances at a same subcarrier, or SRS transmissions using different antenna ports, for example.

In accordance with various techniques as discussed herein, one or more uplink reference signals from a UE may be configured for use by a TRP to estimate a Doppler shift associated with communications with the UE. In some cases, a SRS may be configured as the uplink reference signal for tracking (e.g. an uplink TRS). In some cases, radio resource control (RRC) signaling that configures a SRS may provide an enumerated usage of the SRS as for TRS. In other cases, an RRC parameter may be provided that indicates that a SRS of a different enumerated usage is also configured for TRS (e.g., a SRS with enumerated usage of beam management, codebook, non-codebook, or antenna switching may also be configured for uplink TRS). In some cases, one or more reference signal resources may be configured to provide a signal suitable for TRS, such as time domain resources, frequency domain resources, spatial domain resources, or combinations thereof. In some cases, uplink reference signals for tracking may be transmitted periodically, and may be activated or deactivated via RRC signaling, a medium access control (MAC) control element (CE), downlink control information (DCI), or any combinations thereof. In some cases, such reference signals may be aperiodic and triggered by, for example, a DCI or group common DCI. In some cases, a UE may provide a capability indication to a TRP that indicates whether the UE is capable of configuring an uplink reference signal for tracking. Responsive to the capability indication, one or more TRPs may transmit configuration information to the UE to configure one or more uplink reference signals for tracking. The UE may transmit one or more of the uplink reference signals, which may be used to estimate Doppler metrics in order to provide Doppler compensated communications with the UE.

Various aspects of the subject matter described herein may be implemented to realize one or more of the following potential advantages. The techniques employed by the described UEs may provide benefits and enhancements to the operation of the UEs. For example, operations performed by the UEs may provide improvements to reliability and efficiency in estimations of Doppler metrics. Such Doppler metrics may provide enhanced reliability and efficiency in receiving and decoding Doppler compensated communications with one or multiple TRPs, which may help reduce the likelihood of decoding errors due to uncompensated frequency offsets. Such techniques may be useful in various different situations, such as in cases where a UE is traveling at a relatively high speed in relation to one or more TRPs (e.g., in high speed train (HST) scenarios), and communications may have a relatively large Doppler shifts. The described techniques may thus include features for improvements to reliability in communications, enhanced communications efficiency, and reduced latency.

Aspects of the disclosure are initially described in the context of wireless communications systems. Various examples of reference signal configurations and resources for uplink tracking reference signals are then discussed. Aspects of the disclosure are further illustrated by and described with reference to apparatus diagrams, system diagrams, and flowcharts that relate to uplink tracking reference signal techniques in wireless communications.

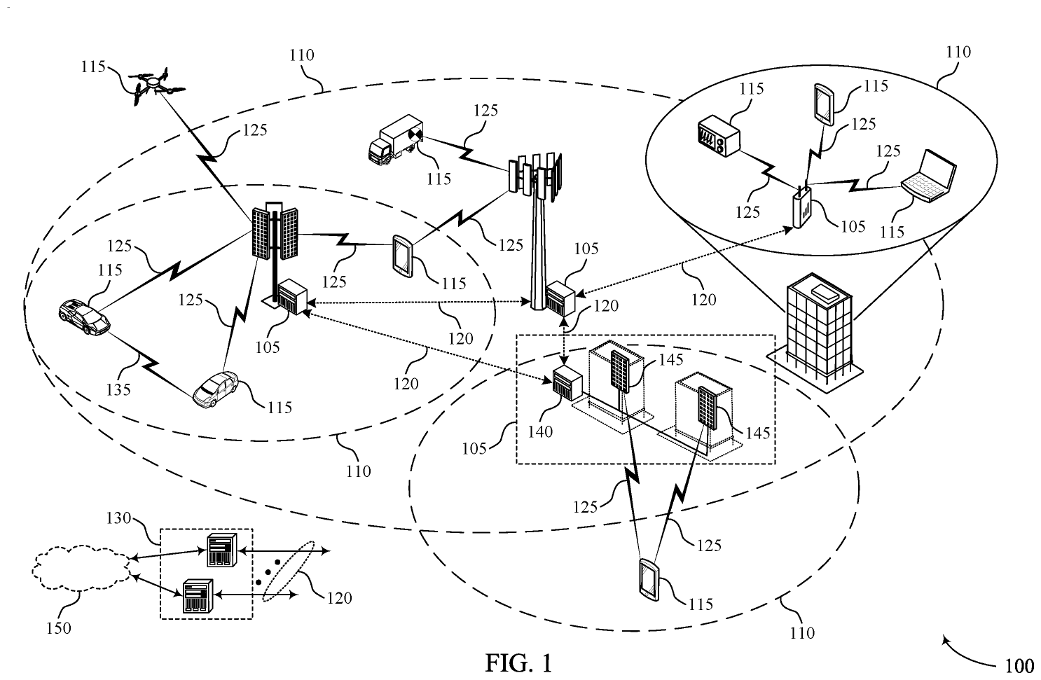

FIG. 1 illustrates an example of a wireless communications system 100 that supports uplink tracking reference signal techniques in wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Δf_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-dDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or TRPs. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS, which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

Wireless communications systems 100 may support deployments in which UEs 115 may move at high speeds relative to one or more base stations 105 (e.g., TRPs). For example, a set of TRPs may be associated with coverage areas 110 that include a high speed train (HST) line. UEs 115 associated with the HST thus may have high mobility, and communications with such UEs 115 may also experience relatively high Doppler effects. In order to provide enhanced reliability in such cases, one or more uplink reference signals for tracking may be configured that may allow one or more TRPs to perform reliable estimations of time and frequency shifts associated with uplink communications from a UE 115.

In some cases, a TRP may Doppler pre-compensate communications with one or more UEs 115 based on one or more Doppler estimates made based on the uplink reference signals for tracking. In some cases, a TRP may configure a SRS as a TRS such as by providing an enumerated usage indication that the SRS is a TRS, or providing an indication that a SRS with a different enumerated usage is also to be used as a TRS. In some cases, such UEs 115 may be configured with SRS configurations that provide time resources, frequency resources, or combinations thereof, that can provide for reliable estimations of time/frequency offsets. In some cases, such UEs 115 may provide a capability indication to one or multiple TRPs that indicates whether the UE 115 is capable of having a SRS configured as a TRS. In some cases, responsive to the capability indication, one or more of the TRPs may transmit configuration information to the UE 115 to configure SRSs for tracking, in accordance with various aspects as discussed herein.

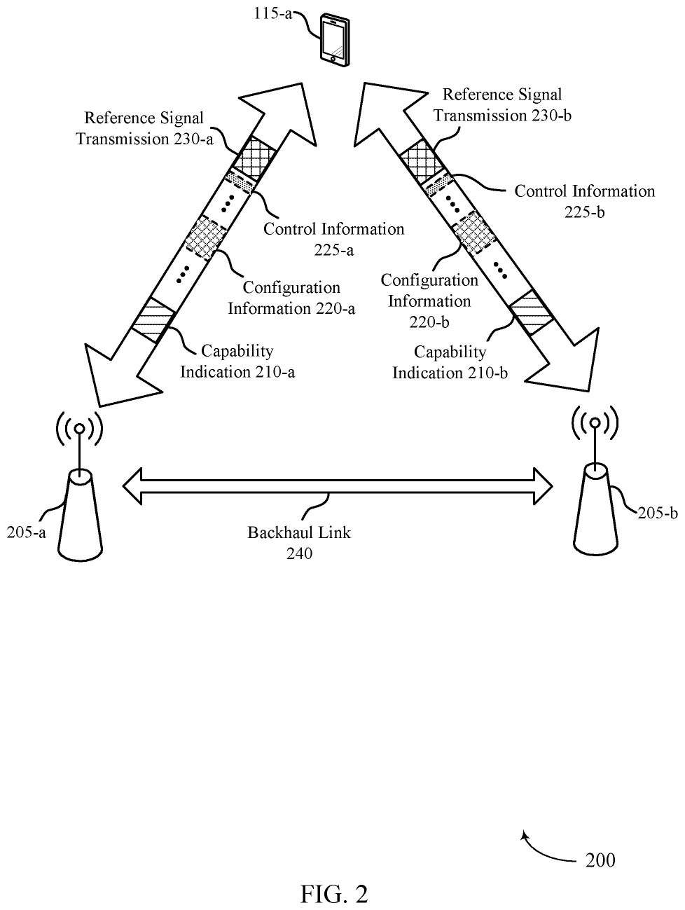

FIG. 2 illustrates an example of a wireless communications system 200 that supports uplink tracking reference signal techniques in wireless communications in accordance with aspects of the present disclosure. In some examples, wireless communications system 200 may implement aspects of wireless communications system 100. The wireless communications system 200 may include a UE 115-a, which may be an example of a UE 115 as described with reference to FIG. 1. Additionally, the wireless communications system 200 may include TRPs 205, which may be examples of access network transmission entities 145 as described with reference to FIG. 1. In wireless communications system 200, the UE 115-a may be configured to communicate with multiple TRPs 205 (e.g., TRP 205-a and TRP 205-b).

The UE 115-a may be in communication with a serving cell by the first TRP 205-a and the second TRP 205-b. In some cases, the UE 115-a may additionally be in communication with additional TRPs 205 associated with the serving cell. In other cases, the UE 115-a may be in communication with only one TRP 205. In cases where the UE 115-a communicated with multiple TRPs 205, the UE 115-a may receive one or more indications (e.g., via RRC signaling, MAC-CE signaling, DCI transmissions, or combinations thereof) of active TCI states associated with communications with the TRP 205-a and the TRP 205-b, in which a same TCI state or different TCI states may be used for the multi-TRP 205 communications.

The UE 115-a may be capable of estimating Doppler metrics associated with the different channels between the UE 115-a and the TRPs 205 (e.g., the channel between the UE 115-a and the TRP 205-a and the channel between the UE 115-a and the TRP 205-b). In some cases, the UE 115-a may transmit a capability indication 210-a that provides the first TRP 205-a with an indication of a capability of the UE 115-a to configure an uplink reference signal for tracking (e.g., a capability to configure SRS as a TRS). Additionally or alternatively, the UE 115-a may transmit capability indication 210-b to the second TRP 205-b with an indication of the capability of the UE 115-a to configure uplink reference signals for tracking. In some cases, the TRP 205 that receives the indication of the UE capability may communicate the UE 115-a capability to the other TRP 205 (e.g., by the backhaul link 240). Based on determining that the UE 115-a is capable of configuring an uplink reference signal for tracking, one or both of the TRPs 205 may transmit configuration information 220 (e.g., via RRC, DCI, MAC-CE, etc.) configuring one or more uplink reference signals for time/frequency tracking. Based on the UE 115-a configuration, one or both of the TRPs 205 may transmit control information 225 (e.g., in DCI or a MAC-CE) that allocates uplink resource in which the UE 115-a can transmit reference signal transmission 230. In some cases, a first reference signal transmission 230-a may be transmitted to the first TRP 205-a based on first control information 225-a, and a second reference signal transmission 230-b may be transmitted to the second TRP 205-b based on second control information 225-b. In some cases, both the first reference signal transmission 230-a and the second reference signal transmission 230-b may be a same transmission by the UE 115-a. In some cases, the reference signal transmission(s) 230 may not use any frequency compensation (i.e., the UE 115-a does not apply Doppler compensation to the reference signal transmission 230).

Additionally, in some cases the UE 115-a may estimate one or more Doppler metrics (e.g., a Doppler shift, a Doppler spread) associated with a TRP from one or more of the TRPs 205. For example, the UE 115-a may estimate a first Doppler shift or a first Doppler spread associated with the first TRP 205-a based on receiving an associated TRS, and the UE 115-a may estimate a second Doppler shift or a second Doppler spread associated with the second TRP 205-b based on receiving an associated TRS. The UE 115-a may use the estimates, alone or in conjunction with time/frequency offset information from a TRP, to perform Doppler pre-compensation on uplink communications with the TRPs 205, to help enhance efficiency and reliability of uplink communications.

In some cases, one or more TRPs 205 (or other network component) can estimate uplink Doppler shifts (e.g., center frequency offsets (CFOs)) based on the corresponding reference signal transmissions 230 (e.g., uplink SRS(s) configured for TRS). The TRPs 205 may use the estimations to compensate downlink transmissions to the UE 115-a using the corresponding CFO. In some cases, the TRPs 205 may provide information to the UE 115-a that indicates that corrections are applied to downlink communications, which the UE 115-a may use to select demodulation and decoding parameters.

In cases where the UE 115-a reports capability for configuring uplink reference signals for tracking, such information may provide one or more capabilities of the UE 115-a. For example, the capability indication 210 may provide capability for configuring uplink reference signals for tracking reporting for each of a number of frequency bands, for one or more combinations of frequency bands, for low-band (e.g., frequency range 1 (FR1) or sub-6 GHz) and high-band (e.g., FR2 or above 6 GHz) communications, or any combinations thereof. In some case, each of multiple different UEs may provide separate per-UE capability reporting, and TRPs 205 may configure communications in accordance with the reported UE capability.

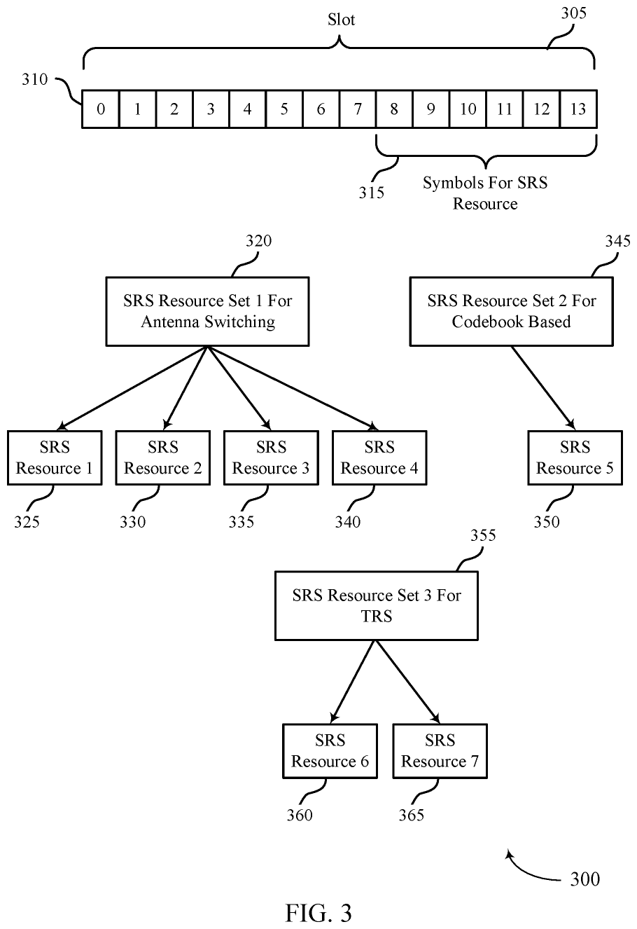

In some cases, a SRS may be configured as the uplink reference signal and provide an uplink TRS. In some cases, the configuration information 220 may be provided by RRC signaling that configures a SRS may provide an enumerated usage of the SRS as for TRS, or an RRC parameter may be provided that indicates that a SRS of a different enumerated usage is also configured for TRS. Examples of SRS usage configurations are discussed in more detail with reference to FIG. 3.

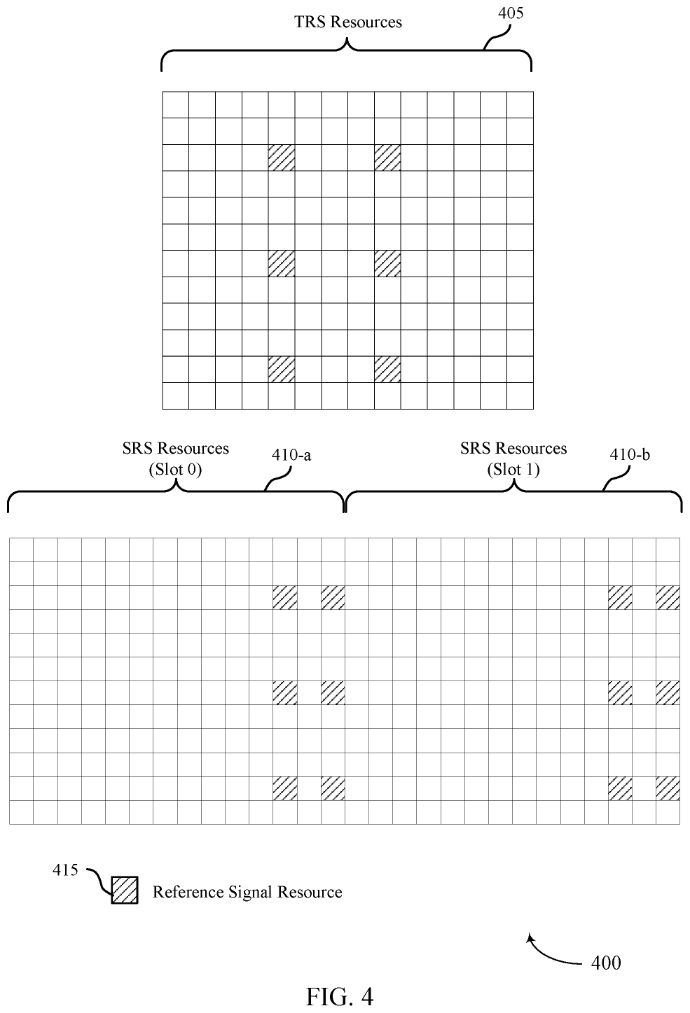

In some cases, one or more reference signal resources may be configured to provide a signal suitable for TRS, such as time domain resources, frequency domain resources, spatial domain resources, or combinations thereof. In some cases, uplink reference signals for tracking (e.g., SRS configured for TRS) may be periodically transmitted, and may be activated or deactivated via RRC signaling, a medium access control (MAC) control element (CE), downlink control information (DCI), or any combinations thereof. In some cases, such reference signals may be aperiodic and triggered by, for example, a DCI or group common DCI. Examples of reference signal resource configurations are discussed in more detail with reference to FIG. 4.

Such techniques may thus allow for enhanced efficiency and reliability in communications between UE 115-a and TRPs 205 through more accurate estimation and compensation for frequency offsets that may be observed in received communications. Such techniques may be advantageous in cases where relatively large and changing Doppler shifts among TRPs 205 may be present, such as in cases where the UE 115-a may have high mobility and travel at a relatively high rate of speed relative to different TRPs 205 (e.g., in HST scenarios where the first TRP 205-a and the second TRP 205-b may have relatively large opposing Doppler shifts).

FIG. 3 illustrates an example of SRS configurations 300 that support uplink tracking reference signal techniques in wireless communications in accordance with aspects of the present disclosure. In some examples, SRS configurations 300 may implement aspects of wireless communications system 100 or 200. As discussed herein, in some cases a SRS may be configured to provide an uplink TRS. Existing SRS configurations may provide that certain symbols 310 within a slot 305 may be used for SRS. In some cases, the last six symbols of a slot 305 may be symbols for SRS resources 315.

In some cases, a SRS resource set configuration may be provided to a UE that indicates a number of parameters for SRSs to be transmitted by the UE. For example, a first SRS resource set 320 may be configured at a UE for antenna switching. In some cases, such a first SRS resource set 320 may be configured with SRS resources 325 through 340 in which the UE is to transmit an established SRS bit sequence that can be measured at a TRP or base station. In some cases, SRS resources 325 through 340 may use different antenna ports which may allow for measurements of different ports. Further, in this example, a second SRS resource set 345 may be configured for codebook based precoding determination, which may have an associated SRS resource 350.

Further, in accordance with some aspects described herein, a third SRS resource set 355 may be configured for TRS, which has associated SRS resources 360 through 365. In some cases, the third SRS resource set 355 may have an enumerated usage indicated in RRC configuration information for TRS. In some existing systems, SRS configurations may provide four enumerated usages, which may be for antenna switching, codebook-based, non-codebook based, and beam management. In some aspects, a fifth enumerated usage for SRS may be for TRS usage, and an associated RRC parameter that indicates the enumerated usage of the SRS configuration may indicate TRS. In such case, configured SRS resources 360-365 may be configured with time/frequency resources that provide for reliable estimation of time/frequency shifts for time/frequency tracking. An example of RRC configuration information for a “usage” option in which an enumerated option includes “TRS” is as follows:

| | |
|---|---|
| SRS-ResourceSet ::= | SEQUENCE { |

| | |
|---|---|
| srs-ResourceSetId | SRS-ResourceSetId, |
| srs-ResourceIdList | SEQUENCE (SIZE (1..maxNrofSRS-ResourcesPerSet)) OF SRS- |

ResourceId OPTIONAL, -- Cond Setup

| | |
|---|---|
| resourceType | CHOICE { |

| aperiodic | SEQUENCE { | |
|---|---|---|
| aperiodicSRS-ResourceTrigger | INTEGER (1..maxNrofSRS-TriggerStates-1), | |
| csi-RS | NZP-CSI-RS-ResourceId | OPTIONAL, -- Cond NonCodebook |

| | | |
|---|---|---|
| slotOffset | INTEGER (1..32) | OPTIONAL, -- Need S |

```
        . . . ,
        [[
        aperiodicSRS-ResourceTriggerList-v1530 SEQUENCE (SIZE(1..maxNrofSRS-
TriggerStates-2))
```

OF INTEGER (1..maxNrofSRS-TriggerStates-1) OPTIONAL -- Need M

```
        ]]
    },
```

| | |
|---|---|
| semi-persistent | SEQUENCE { |

| | | |
|---|---|---|
| associatedCSI-RS | NZP-CSI-RS-ResourceId | OPTIONAL, -- Cond NonCodebook |

```
      ...
    },
```

| | |
|---|---|
| periodic | SEQUENCE { |

| | | |
|---|---|---|
| associatedCSI-RS | NZP-CSI-RS-ResourceId | OPTIONAL, -- Cond NonCodebook |

```
          ...
    }
  },
```

| | |
|---|---|
| usage | ENUMERATED {beamManagement, codebook, nonCodebook, antennaSwitching, TRS}, |

| | | |
|---|---|---|
| alpha | Alpha | OPTIONAL, -- Need S |
| p0 | INTEGER (−202..24) | OPTIONAL, -- Cond Setup |

| | |
|---|---|
| pathlossReferenceRS | CHOICE { |

| | |
|---|---|
| ssb-Index | SSB-Index, |
| csi-RS-Index | NZP-CSI-RS-ResourceId |

| | |
|---|---|
| } | OPTIONAL, -- Need M |

| | |
|---|---|
| srs-PowerControlAdjustmentStates | ENUMERATED { sameAsFci2, separateClosedLoop} |

OPTIONAL, -- Need S

In other cases, an RRC parameter may be provided with an SRS configuration that enumerates a different usage for the SRS. For example, the first SRS resource set 320 may have the enumerated usage for antenna switching, but an RRC parameter within the SRS configuration may be set to indicate that TRS usage is true, which indicates that the SRS resource set may also be used for TRS, in addition to the enumerated usage of antenna switching. Similarly, the second SRS resource set 345 may have a similar indication. In cases where the TRS usage is set to true, the associated SRS resources may be configured to provide reference signal transmissions that may be used to estimate time/frequency shifts, along with estimations for the enumerated usage of the SRS resource set. An example of RRC configuration information with an RRC parameter of “trs-Info” to indicate TRS usage for a SRS resource set with a different enumerated option is as follows:

| | |
|---|---|
| SRS-ResourceSet ::= | SEQUENCE { |

| | |
|---|---|
| srs-ResourceSetId | SRS-ResourceSetId, |
| srs-ResourceIdList | SEQUENCE (SIZE(1..maxNrofSRS-ResourcesPerSet)) OF SRS- |

ResourceId OPTIONAL, -- Cond Setup

| | |
|---|---|
| resourceType | CHOICE { |
| aperiodic | SEQUENCE { |

| aperiodicSRS-ResourceTrigger | INTEGER (1..maxNrofSRS-TriggerStates-1), | |
|---|---|---|
| csi-RS | NZP-CSI-RS-ResourceId | OPTIONAL, -- Cond NonCodebook |

| | | |
|---|---|---|
| slotOffset | INTEGER (1..32) | OPTIONAL, -- Need S |

```
      ...,
      [[
      aperiodicSRS-ResourceTriggerList-v1530 SEQUENCE (SIZE(1..maxNrofSRS-
TriggerStates-2))
        OF INTEGER (1..maxNrofSRS-TriggerStates-1) OPTIONAL -- Need M
      ]]
      },
```

| semi-persistent | SEQUENCE { | |
|---|---|---|
| associatedCSI-RS | NZP-CSI-RS-ResourceId | OPTIONAL, -- Cond NonCodebook |

```
      ...
    },
```

| periodic | SEQUENCE { | |
|---|---|---|
| associatedCSI-RS | NZP-CSI-RS-ResourceId | OPTIONAL, -- Cond NonCodebook |

```
      ...
    }
},
```

| | |
|---|---|
| usage | ENUMERATED {beamManagement, codebook, nonCodebook, |

antennaSwitching},

| | |
|---|---|
| alpha | Alpha |

OPTIONAL, -- Need S

| | | |
|---|---|---|
| p0 | INTEGER (−202..24) | OPTIONAL, -- Cond Setup |

| | |
|---|---|
| pathlossReferenceRS | CHOICE { |

| | |
|---|---|
| ssb-Index | SSB-Index, |
| csi-RS-Index | NZP-CSI-RS-ResourceId |

| | |
|---|---|
| } | OPTIONAL, -- Need M |

| | |
|---|---|
| srs-PowerControlAdjustmentStates | ENUMERATED { sameAsFci2, separateClosedLoop} |

OPTIONAL, -- Need S

| | |
|---|---|
| trs-Info | ENUMERATED {true} |

...
}

FIG. 4 illustrates an example of reference signal resources 400 that support uplink tracking reference signal techniques in wireless communications in accordance with aspects of the present disclosure. In some examples, reference signal resources 400 may implement aspects of wireless communications system 100 or 200. In this example, a set of TRS resources 405 may include one or more resource elements allocated for reference signal resources 415, which may be an example of downlink TRS configuration. Further, a set of SRS resources 410 may be provided that include first SRS resources 410-a in a first slot and second SRS resources 410-b in a second slot, which each include resource elements allocated for reference signal resources 415.

The TRS resource 405, in some cases, may be a special configuration of CSI-RS resources that are configured to provide CSI-RS for tracking. The reference signal resources 415 may be located in multiple OFDM symbols in one slot with a gap (e.g., a three symbol gap). Further, the reference signal resources 415 may occupy multiple subcarriers with a gap. Such a configuration may provide time separation of TRS instances, and frequency separation of TRS instances, such that time and frequency tracking may be performed.

As discussed above, SRS resources 410 may be configured in which the last six OFDM symbols of a slot contain the reference signal resources 415. In cases where SRS is configured for TRS, the OFDM symbols and subcarriers of the reference signal resources 415 within the SRS resources 410 may be configured to provide time and frequency gaps in a similar manner as provided for TRS resources 405. In some cases, time domain resources for uplink TRS may be configured such that one SRS resource set has at least two SRS resources in a slot (e.g., as indicated in first SRS resources 410-a in a first slot). In other cases, at least two SRS resource sets may be configured on back-to-back slots (i.e., two consecutive slots), such as indicated in first SRS resources 410-a and second SRS resources 410-b in consecutive slots. In some case, the two (or more) SRS resources 410 in one SRS resource set may be located with a 2 or 4 symbols gap. In some cases, the time domain resources may be different for FR1 and FR2. In some cases, frequency domain resources may be selected to provide a frequency gap. For example, reference signal resources 415 may be provided in a fixed comb (e.g., all the SRSs for tracking use comb 4 or all the SRSs for tracking use comb 2). In some cases, spatial domain resource may be provided such that at least two instances of a reference signal use a single antenna port. Additionally, the SRS resources 410 may be configured such that a same power is used across instances of a reference signal.

In some cases, SRS resources for TRS may be configured to be periodically transmitted by a UE (e.g., based on a semi-persistent period that is configured by RRC or a MAC-CE). In such cases, reference signal resources 415 in the SRS resource set 410 may be configured with same periodicity, bandwidth and subcarrier location. In some cases, semi-persistent uplink TRSs may be configured by RRC and may be activated/deactivated by a MAC-CE or DCI. In further, cases, uplink TRS transmissions can be aperiodic. Aperiodic uplink TRSs may be triggered, in some examples, by DCI for one UE or group-common DCI for multiple UEs. In some cases, activation/deactivation/triggering commands for uplink TRS may reuse the mechanism for activation/deactivation/triggering of SRSs. Additionally, in some cases the UE may transmit uplink TRS without uplink carrier frequency correction (i.e. the UE does not feed CFO to UL XO or digital rotator).

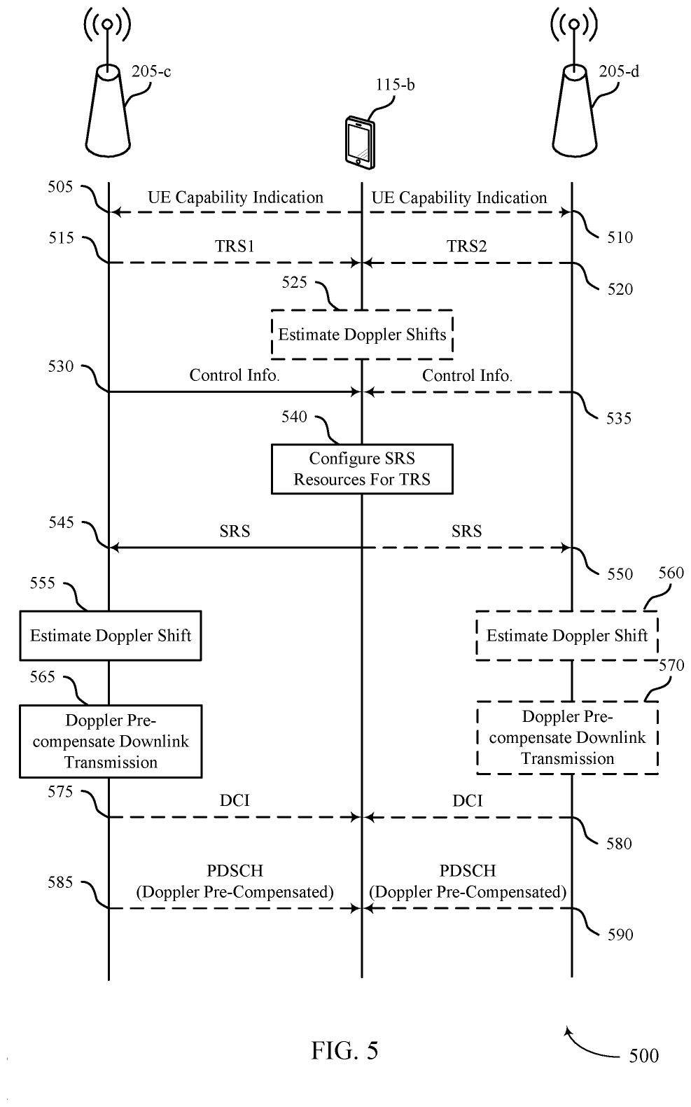

FIG. 5 illustrates an example of a process flow 500 that supports uplink tracking reference signal techniques in wireless communications in accordance with aspects of the present disclosure. In some examples, process flow 500 may implement aspects of wireless communications system 100 or 200. Process flow may include a UE 115-b, a first TRP 205-c, and a second TRP 205-d, which may each be examples of UEs and TRPs as described with reference to FIGS. 1 through 3. Additionally, TRPs 205 may be a part of a same base station, or be associated with different base stations, that may be examples a base station as described with reference to FIGS. 1 and 2. Further, TRPs 205 may be RRHs that are associated with same or different TRPs.

At 505, optionally, the UE 115-b may transmit a UE capability indication to the first TRP 205-c. The UE capability indication may indicate to the first TRP 205-c uplink reference signal for tracking capabilities of the UE 115-b (e.g., that the UE 115-b is capable of configuring SRS for TRS). At 510, the UE 115-b optionally may transmit the UE capability indication to the second TRP 205-d. That is, the UE 115-b may transmit the UE capability indication to the second TRP 205-d instead of transmitting the UE capability to the first TRP 205-c at 505. In some other cases, the UE 115-b may transmit the UE capability indication to both the first TRP 205-c and the second TRP 205-d.

At 515, the first TRP 205-c optionally may transmit a first TRS (or other reference signal) to the UE 115-b. In some cases, the first TRP 205-c may transmit the reference signal based on receiving a UE capability indication indicating that the UE 115-b may estimate a Doppler shift associated with the reference signal. At 530, the second TRP 205-d optionally may transmit a second TRS (or other reference signal) to the UE 115-b. In some cases, the second TRP 205-d may transmit the reference signal based on receiving a UE capability indication indicating that the UE 115-b may estimate a Doppler shift associated with the reference signal. In some cases, the reference signals may be a TRS, an SSB transmission, a CSI-RS, or a combination thereof.

At 525, in some cases, the UE 115-b may estimate a first Doppler shift associated with the first TRP 205-c and a second Doppler shift associated with the second TRP 205-d. In some cases, the UE 115-b may estimate the first Doppler shift based on the reference signal received from the first TRP 205-c. In some cases, the UE may estimate the second Doppler shift based on the reference signal received from the second TRP 205-d.

At 530, the first TRP 205-c may transmit control information to the UE 115-b that configures one or more uplink reference signals for tracking, in accordance with techniques as discussed herein. In some cases, the control information may configure a usage of a SRS to be for an uplink TRS. In some cases, the control information may provide an allocation of resources for one or more uplink transmissions that are to include the uplink reference signal. In some cases, when the UE 115-a estimates Doppler shifts associated with the TRPs 205, the control information may also indicate a set of resources for transmitting one or more Doppler shift indications to the first TRP 205-c or the second TRP 205-d, or both. At 535, the second TRP 205-d may optionally transmit control information to the UE 115-a that provides such configuration information. For example, the second TRP 205-d may transmit the control information to the UE 115-b in a case that the first TRP 205-c does not transmit the control information to the UE 115-b.

At 540, the UE 115-b may configure the uplink reference signal for tracking. In some cases, the UE 115-b may configure one or more SRS resource sets for a TRS usage based on the configuration information. At 545, the UE 115-a may transmit a first SRS to the first TRP 205-c, in which the first SRS is configured for TRS either alone or in conjunction with another usage of the SRS. Likewise, at 560, the UE 115-a optionally may transmit a second SRS to the second TRP 205-d. In some cases, the UE 115-a may not compensate the uplink center frequency for the SRS(s) based on Doppler shifts that are estimated for the TRPs 205.

At 555, the first TRP 205-c may estimate a Doppler shift associated with the SRS from the UE 115-b. Likewise, in this example, at 560, the second TRP 205-d may also estimate a Doppler shift associated with the SRS from the UE 115-b, In some cases, each TRP 205 may measure a frequency offset associated with the UE 115-b based on the SRS from the UE 115-b, and use the measured frequency offset to determine a Doppler compensation for communications with the UE 115-b.

At 565, the first TRP 205-c may Doppler pre-compensate a downlink transmission (e.g., a PDSCH transmission) based on the estimated Doppler shift. At 570, the second TRP 205-d optionally may Doppler pre-compensate a downlink transmission (e.g., a PDSCH transmission) based on the estimated Doppler shift. In some cases, one or both TRPs 205 may not Doppler pre-compensate their respective downlink transmissions.

Optionally, at 575, the first TRP 205-c may transmit a DCI to the UE 115-b that schedules a PDSCH communication. In some cases, the DCI may include an indication of whether the PDSCH communication is Doppler pre-compensated or not. Additionally or alternatively, at 580, the second TRP 205-d may optionally transmit a DCI to the UE 115-b that schedules a PDSCH communication, and the DCI may include an indication of whether the PDSCH communication is Doppler pre-compensated or not. At 585, optionally the first TRP 205-c may transmit a Doppler pre-compensated downlink transmission to the UE 115-b via a PDSCH. At 590, the second TRP 205-d optionally may transmit a Doppler compensated downlink transmission to the UE 115-b via the PDSCH. In some cases, the UE 115-b may select a TCI state for the PDSCHs based on the Doppler pre-compensation, and a quasi-co-location (QCL) relation with the TRPs 205 may be selected based on the Doppler pre-compensation.

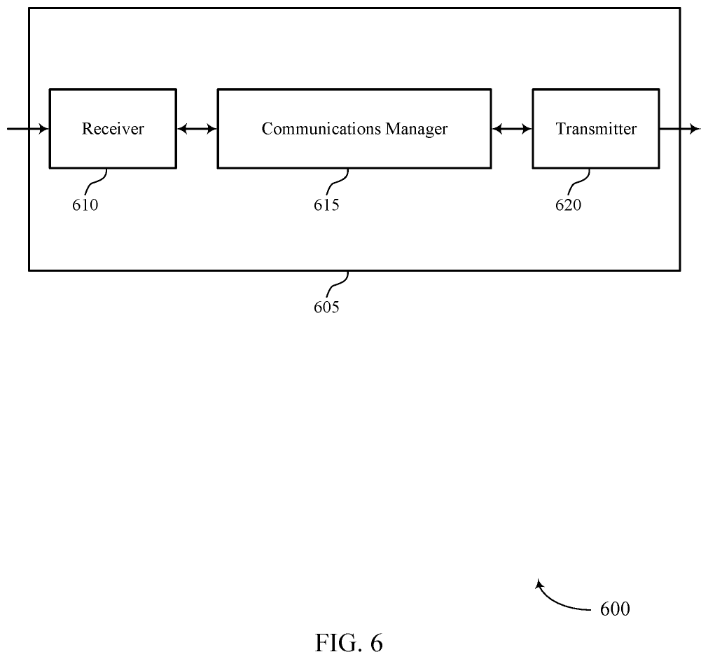

FIG. 6 shows a block diagram 600 of a device 605 that supports uplink tracking reference signal techniques in wireless communications in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

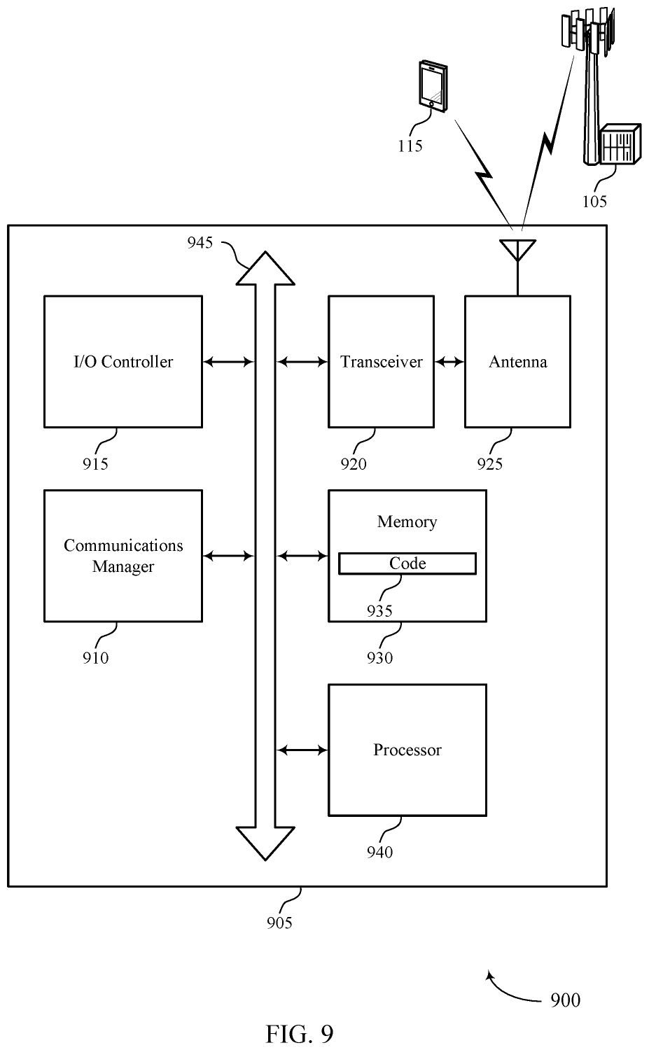

The receiver 610 may receive information such as packets, user data, or control information associated with various information channels (e.g., control channels, data channels, and information related to uplink tracking reference signal techniques in wireless communications, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may receive, from a first transmission-reception point, control information that provides an indication that a first uplink reference signal is to be transmitted from the UE to provide one or more of frequency tracking or time tracking for uplink transmissions between the UE and one or more transmission-reception points, select, based on the indication, a reference signal configuration for the first uplink reference signal from a set of available reference signal configurations, and transmit the first uplink reference signal based on the reference signal configuration.

The communications manager 615 may also receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points, configure at least a first sounding reference signal resource set for uplink tracking based on the configuration information, and transmit a first sounding reference signal based on the first sounding reference signal resource set.

The communications manager 615 may also transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points, receive, from the first transmission-reception point responsive to the uplink tracking capability indication, configuration information for at least a first sounding reference signal resource set that configures a first uplink sounding reference signal for uplink tracking, and transmit the first uplink sounding reference signal to one or more transmission-reception points based on the configuration information. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

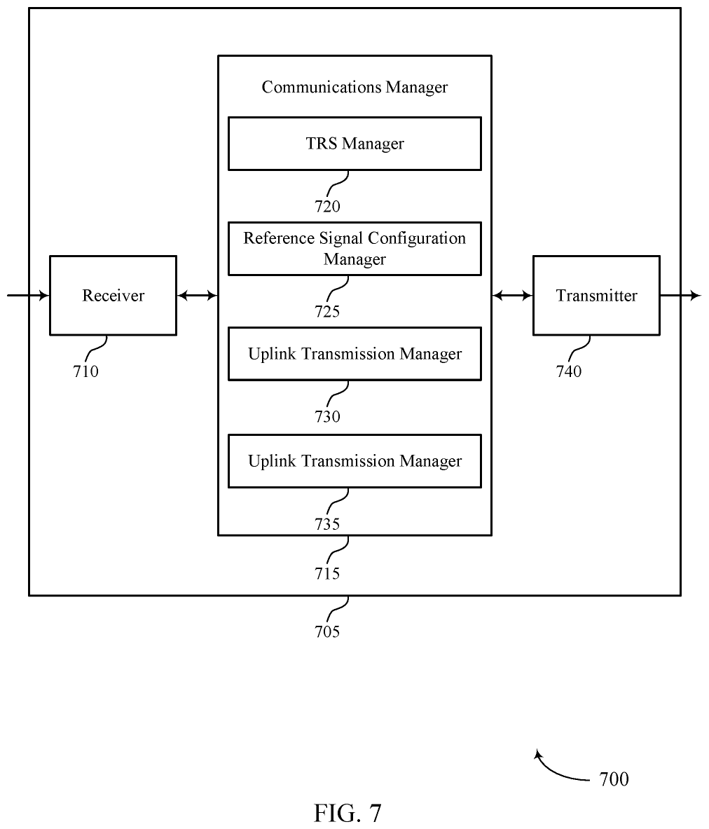

FIG. 7 shows a block diagram 700 of a device 705 that supports uplink tracking reference signal techniques in wireless communications in accordance with aspects of the present disclosure. The device 705 may be an example of aspects of a device 605, or a UE 115 as described herein. The device 705 may include a receiver 710, a communications manager 715, and a transmitter 740. The device 705 may also include a processor. Each of these components may be in communication with one another (e.g., via one or more buses).

The receiver 710 may receive information such as packets, user data, or control information associated with various information channels (e.g., control channels, data channels, and information related to uplink tracking reference signal techniques in wireless communications, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a TRS manager 720, a reference signal configuration manager 725, an uplink transmission manager 730, and a capability indication manager 735. The communications manager 715 may be an example of aspects of the communications manager 910 described herein.

In some cases, the TRS manager 720 may receive, from a first transmission-reception point, control information that provides an indication that a first uplink reference signal is to be transmitted from the UE to provide one or more of frequency tracking or time tracking for uplink transmissions between the UE and one or more transmission-reception points. The reference signal configuration manager 725 may select, based on the indication, a reference signal configuration for the first uplink reference signal from a set of available reference signal configurations. The uplink transmission manager 730 may transmit the first uplink reference signal based on the reference signal configuration.

In some cases, the reference signal configuration manager 725 may receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points. The TRS manager 720 may configure at least a first sounding reference signal resource set for uplink tracking based on the configuration information. The uplink transmission manager 730 may transmit a first sounding reference signal based on the first sounding reference signal resource set.

In some cases, the capability indication manager 735 may transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points. The reference signal configuration manager 725 may receive, from the first transmission-reception point responsive to the uplink tracking capability indication, configuration information for at least a first sounding reference signal resource set that configures a first uplink sounding reference signal for uplink tracking. The uplink transmission manager 730 may transmit the first uplink sounding reference signal to one or more transmission-reception points based on the configuration information.

The transmitter 740 may transmit signals generated by other components of the device 705. In some examples, the transmitter 740 may be collocated with a receiver 710 in a transceiver module. For example, the transmitter 740 may be an example of aspects of the transceiver 920 described with reference to FIG. 9. The transmitter 740 may utilize a single antenna or a set of antennas.

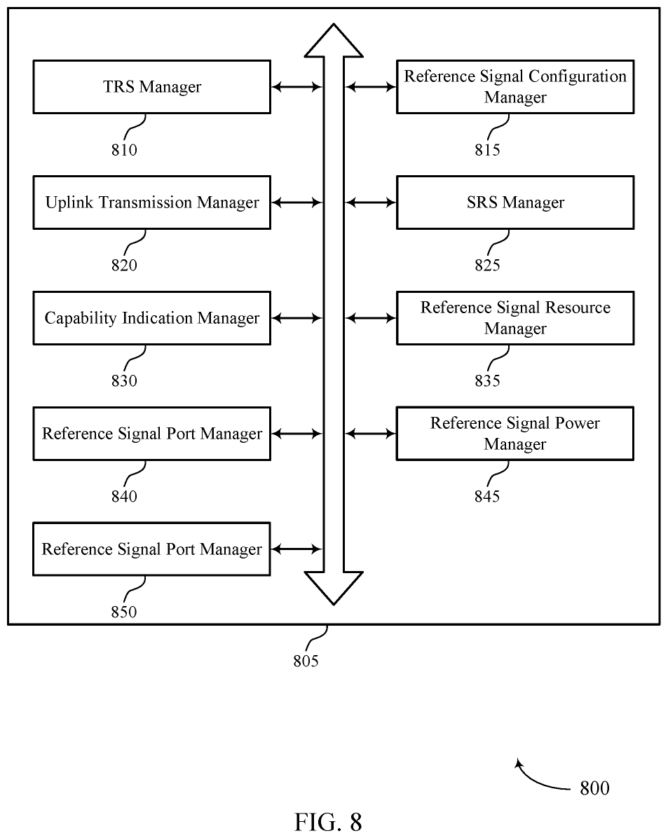

FIG. 8 shows a block diagram 800 of a communications manager 805 that supports uplink tracking reference signal techniques in wireless communications in accordance with aspects of the present disclosure. The communications manager 805 may be an example of aspects of a communications manager 615, a communications manager 715, or a communications manager 910 described herein. The communications manager 805 may include a TRS manager 810, a reference signal configuration manager 815, an uplink transmission manager 820, a SRS manager 825, a capability indication manager 830, a reference signal resource manager 835, a reference signal port manager 840, a reference signal power manager 845, and a TRS activation manager 850. Each of these modules may communicate, directly or indirectly, with one another (e.g., via one or more buses).

The TRS manager 810 may receive, from a first transmission-reception point, control information that provides an indication that a first uplink reference signal is to be transmitted from the UE to provide one or more of frequency tracking or time tracking for uplink transmissions between the UE and one or more transmission-reception points. In some examples, the TRS manager 810 may configure at least a first sounding reference signal resource set for uplink tracking based on the configuration information.

The reference signal configuration manager 815 may select, based on the indication, a reference signal configuration for the first uplink reference signal from a set of available reference signal configurations. In some examples, the reference signal configuration manager 815 may receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points. In some examples, the reference signal configuration manager 815 may receive, from the first transmission-reception point responsive to the uplink tracking capability indication, configuration information for at least a first sounding reference signal resource set that configures a first uplink sounding reference signal for uplink tracking. In some examples, the reference signal configuration manager 815 may receive configuration information for the first uplink reference signal that configures one or more of time resources or frequency resources of a sounding reference signal resource set for uplink tracking.

The uplink transmission manager 820 may transmit the first uplink reference signal based on the reference signal configuration. In some examples, the uplink transmission manager 820 may transmit a first sounding reference signal based on the first sounding reference signal resource set. In some cases, the transmission configuration indicates that the first sounding reference signal is to be transmitted without an uplink carrier frequency correction.

The capability indication manager 830 may transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points. In some examples, the capability indication manager 830 may transmit, prior to the receiving the control information, a capability indication to the first transmission-reception point that indicates a UE capability to use a sounding reference signal for uplink tracking. In some cases, the uplink tracking capability indication is transmitted to the first transmission-reception point in radio resource control signaling during a connection establishment procedure for the UE.

The SRS manager 825 may receive a usage indication that indicates a sounding reference signal is to be used as an uplink tracking reference signal. In some cases, the usage indication is provided as an enumerated usage in a radio resource configuration parameter for a sounding reference signal resource set. In some cases, the sounding reference signal resource set having the enumerated usage indication for the uplink tracking reference signal is configured only for uplink tracking reference signal usage. In some cases, the usage indication is provided as a separate radio resource configuration parameter for a sounding reference signal resource set that has a different enumerated usage. In some cases, the different enumerated usage for the sounding reference signal includes one or more of a usage for antenna switching, codebook-based precoding measurements, non-codebook-based precoding measurements, or beam management.

The reference signal resource manager 835 may identify time/frequency domain configuration of resources for transmission of uplink reference signals. In some cases, the configuration information includes one or more of a time domain configuration, a frequency domain configuration, a spatial domain configuration, a power configuration, a periodicity configuration, an activation command configuration, a transmission configuration, or any combinations thereof, for the first sounding reference signal resource set. In some cases, the time domain configuration provides at least two time domain resources for transmission of the first sounding reference signal within the first sounding reference signal resource set. In some cases, the time domain configuration provides at least two sounding reference signal resource sets in two or more consecutive uplink slots. In some cases, the time domain configuration provides at least two time domain resources for transmission of the first sounding reference signal with a two or a four symbol time domain gap, the time domain configuration provides separate configurations for a low-band frequency range and a high-band frequency range, or any combinations thereof. In some cases, the frequency domain configuration indicates that a same fixed subcarrier comb pattern is used across a set of time domain resources for transmitting the first sounding reference signal. In some cases, the periodicity configuration indicates a fixed periodicity for a set of transmissions of the first sounding reference signal. In some cases, the set of transmissions of the first sounding reference signal are configured with a same periodicity, a same frequency bandwidth, and a same set of subcarrier locations.

The reference signal port manager 840 may identify a spatial domain configuration that indicates that the first sounding reference signal is transmitted using a single antenna port.

The reference signal power manager 845 may identify a power configuration indicates that indicates the first sounding reference signal is transmitted at a same transmit power across all sounding reference signal resources of the first sounding reference signal resource set.

The TRS activation manager 850 may identify activation/deactivation/triggering commands for TRS. In some cases, the set of transmissions of the first sounding reference signal are activated by a MAC-CE. In some cases, the first sounding reference signal is transmitted aperiodically in response to a trigger received at the UE. In some cases, the trigger is received in one or more of a DCI communication for the UE or in a group common DCI for a set of UEs. In some cases, the activation command configuration provides an activation, deactivation, or triggering of the first sounding reference signal resource set based on a sounding reference signal activation command.

FIG. 9 shows a diagram of a system 900 including a device 905 that supports uplink tracking reference signal techniques in wireless communications in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive, from a first transmission-reception point, control information that provides an indication that a first uplink reference signal is to be transmitted from the UE to provide one or more of frequency tracking or time tracking for uplink transmissions between the UE and one or more transmission-reception points, select, based on the indication, a reference signal configuration for the first uplink reference signal from a set of available reference signal configurations, and transmit the first uplink reference signal based on the reference signal configuration.

The communications manager 910 may also receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points, configure at least a first sounding reference signal resource set for uplink tracking based on the configuration information, and transmit a first sounding reference signal based on the first sounding reference signal resource set.

The communications manager 910 may also transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points, receive, from the first transmission-reception point responsive to the uplink tracking capability indication, configuration information for at least a first sounding reference signal resource set that configures a first uplink sounding reference signal for uplink tracking, and transmit the first uplink sounding reference signal to one or more transmission-reception points based on the configuration information.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting uplink tracking reference signal techniques in wireless communications).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

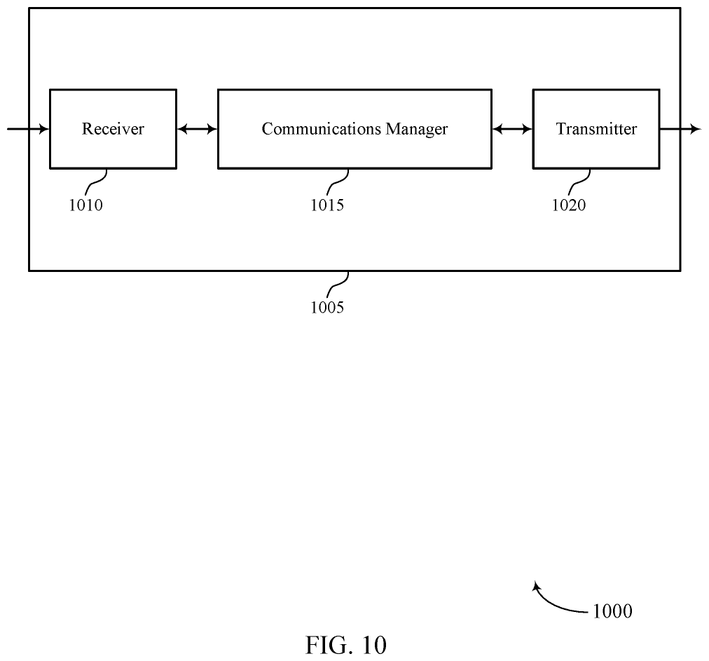

FIG. 10 shows a block diagram 1000 of a device 1005 that supports uplink tracking reference signal techniques in wireless communications in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

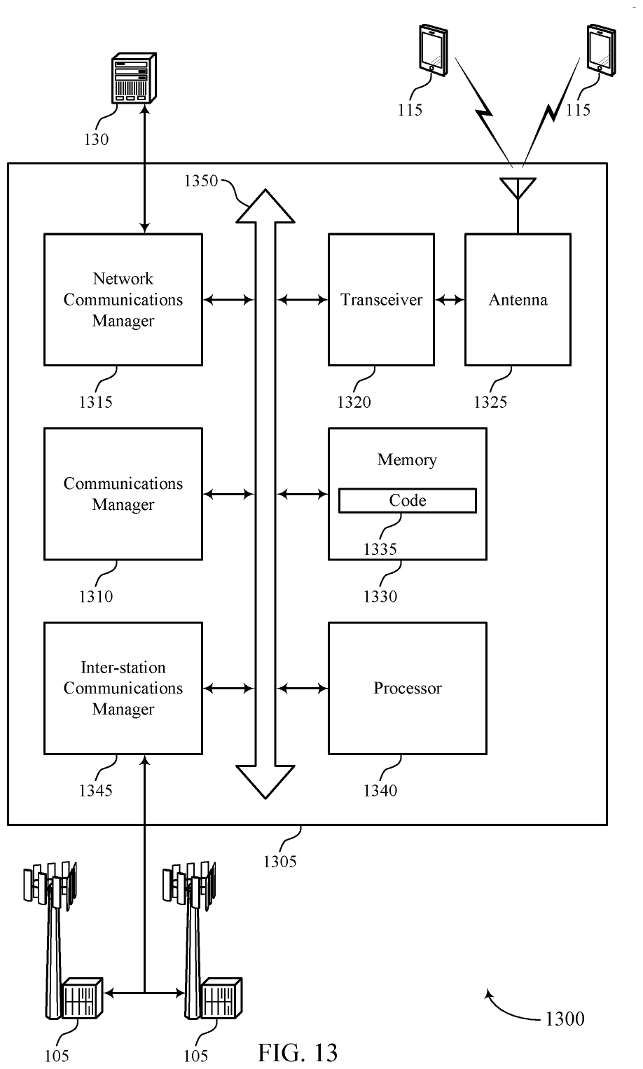

The receiver 1010 may receive information such as packets, user data, or control information associated with various information channels (e.g., control channels, data channels, and information related to uplink tracking reference signal techniques in wireless communications, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may transmit, to a UE, control information that provides an indication that a first uplink reference signal is to be transmitted from the UE to provide one or more of frequency tracking or time tracking for uplink transmissions between the UE and one or more transmission-reception points, monitor, based on the indication, for the first uplink reference signal, and calculate one or more of a frequency shift or a time shift associated with uplink transmissions from the UE based on the first uplink reference signal.

The communications manager 1015 may also transmit, to a UE, configuration information for a sounding reference signal resource set that configures an uplink sounding reference signal for uplink tracking of one or more of frequency shifts or time shifts associated with uplink transmissions between the UE and one or more transmission-reception points, monitor, based on the configuration information, for a first sounding reference signal, and calculate one or more of a frequency shift or a time shift associated with uplink transmissions from the UE based on the first sounding reference signal.

The communications manager 1015 may also receive, from a UE, an uplink tracking capability indication that signals one or more capabilities of the UE for using a sounding reference signal as an uplink tracking reference signal for one or more of frequency tracking or time tracking for uplink transmissions from the UE, transmit to the UE, responsive to the uplink tracking capability indication, configuration information for at least a first sounding reference signal resource set that configures a first uplink sounding reference signal for uplink tracking, and receive the first uplink sounding reference signal from the UE based on the configuration information. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

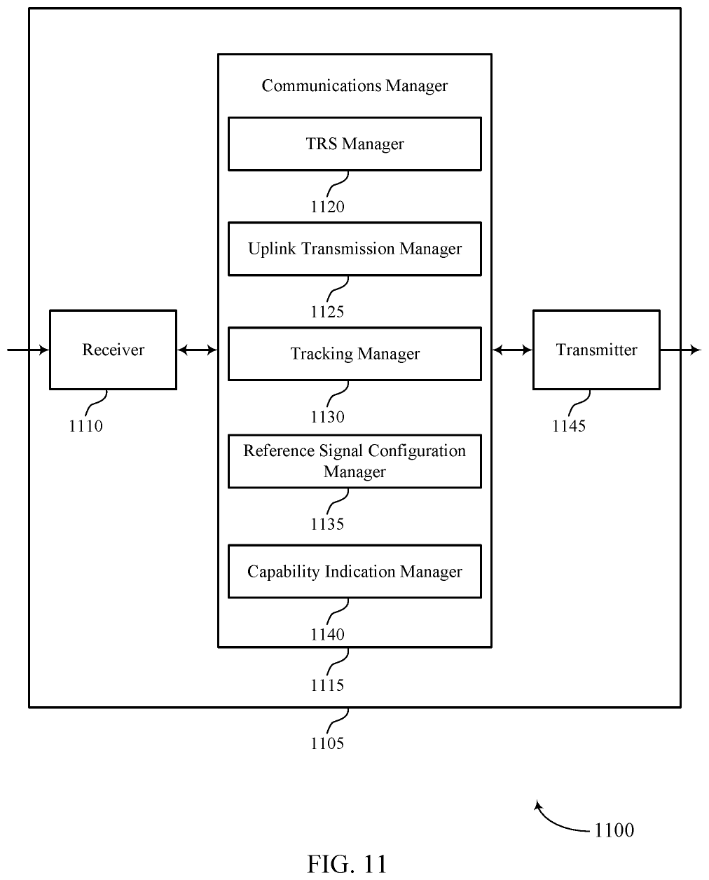

FIG. 11 shows a block diagram 1100 of a device 1105 that supports uplink tracking reference signal techniques in wireless communications in accordance with aspects of the present disclosure. The device 1105 may be an example of aspects of a device 1005, or a base station 105 as described herein. The device 1105 may include a receiver 1110, a communications manager 1115, and a transmitter 1145. The device 1105 may also include a processor. Each of these components may be in communication with one another (e.g., via one or more buses).

The receiver 1110 may receive information such as packets, user data, or control information associated with various information channels (e.g., control channels, data channels, and information related to uplink tracking reference signal techniques in wireless communications, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a TRS manager 1120, an uplink transmission manager 1125, a tracking manager 1130, a reference signal configuration manager 1135, and a capability indication manager 1140. The communications manager 1115 may be an example of aspects of the communications manager 1310 described herein.

In some cases, the TRS manager 1120 may transmit, to a UE, control information that provides an indication that a first uplink reference signal is to be transmitted from the UE to provide one or more of frequency tracking or time tracking for uplink transmissions between the UE and one or more transmission-reception points. The uplink transmission manager 1125 may monitor, based on the indication, for the first uplink reference signal. The tracking manager 1130 may calculate one or more of a frequency shift or a time shift associated with uplink transmissions from the UE based on the first uplink reference signal.

In some cases, the reference signal configuration manager 1135 may transmit, to a UE, configuration information for a sounding reference signal resource set that configures an uplink sounding reference signal for uplink tracking of one or more of frequency shifts or time shifts associated with uplink transmissions between the UE and one or more transmission-reception points. The uplink transmission manager 1125 may monitor, based on the configuration information, for a first sounding reference signal. The tracking manager 1130 may calculate one or more of a frequency shift or a time shift associated with uplink transmissions from the UE based on the first sounding reference signal.

In some cases, the capability indication manager 1140 may receive, from a UE, an uplink tracking capability indication that signals one or more capabilities of the UE for using a sounding reference signal as an uplink tracking reference signal for one or more of frequency tracking or time tracking for uplink transmissions from the UE. The reference signal configuration manager 1135 may transmit to the UE, responsive to the uplink tracking capability indication, configuration information for at least a first sounding reference signal resource set that configures a first uplink sounding reference signal for uplink tracking. The uplink transmission manager 1125 may receive the first uplink sounding reference signal from the UE based on the configuration information.

The transmitter 1145 may transmit signals generated by other components of the device 1105. In some examples, the transmitter 1145 may be collocated with a receiver 1110 in a transceiver module. For example, the transmitter 1145 may be an example of aspects of the transceiver 1320 described with reference to FIG. 13. The transmitter 1145 may utilize a single antenna or a set of antennas.

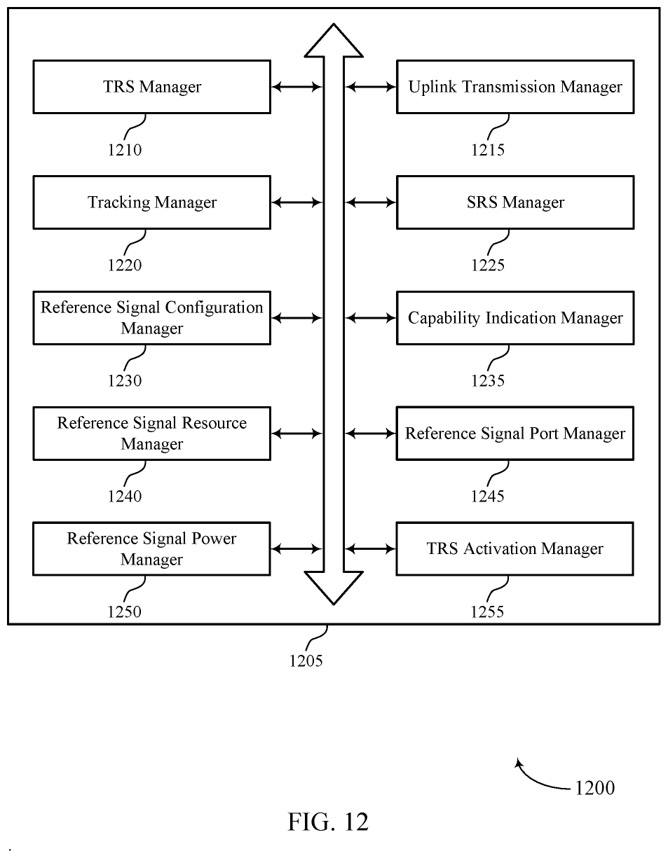

FIG. 12 shows a block diagram 1200 of a communications manager 1205 that supports uplink tracking reference signal techniques in wireless communications in accordance with aspects of the present disclosure. The communications manager 1205 may be an example of aspects of a communications manager 1015, a communications manager 1115, or a communications manager 1310 described herein. The communications manager 1205 may include a TRS manager 1210, an uplink transmission manager 1215, a tracking manager 1220, a SRS manager 1225, a reference signal configuration manager 1230, a capability indication manager 1235, a reference signal resource manager 1240, a reference signal port manager 1245, a reference signal power manager 1250, and a TRS activation manager 1255. Each of these modules may communicate, directly or indirectly, with one another (e.g., via one or more buses).

The TRS manager 1210 may transmit, to a UE, control information that provides an indication that a first uplink reference signal is to be transmitted from the UE to provide one or more of frequency tracking or time tracking for uplink transmissions between the UE and one or more transmission-reception points.

The uplink transmission manager 1215 may monitor, based on the indication, for the first uplink reference signal. In some examples, the uplink transmission manager 1215 may receive the first uplink sounding reference signal from the UE based on the configuration information. The tracking manager 1220 may calculate one or more of a frequency shift or a time shift associated with uplink transmissions from the UE based on the first uplink reference signal.

The reference signal configuration manager 1230 may transmit, to a UE, configuration information for a sounding reference signal resource set that configures an uplink sounding reference signal for uplink tracking of one or more of frequency shifts or time shifts associated with uplink transmissions between the UE and one or more transmission-reception points. In some examples, the reference signal configuration manager 1230 may transmit to the UE, responsive to the uplink tracking capability indication, configuration information for at least a first sounding reference signal resource set that configures a first uplink sounding reference signal for uplink tracking.

In some examples, the reference signal configuration manager 1230 may transmit configuration information to the UE for the first uplink reference signal that configures one or more of time resources or frequency resources of a sounding reference signal resource set for uplink tracking. In some cases, the transmission configuration indicates that the first sounding reference signal is to be transmitted without an uplink carrier frequency correction.

The capability indication manager 1235 may receive, from a UE, an uplink tracking capability indication that signals one or more capabilities of the UE for using a sounding reference signal as an uplink tracking reference signal for one or more of frequency tracking or time tracking for uplink transmissions from the UE. In some cases, the uplink tracking capability indication is received in radio resource control signaling during a connection establishment procedure for the UE.

The SRS manager 1225 may transmit a usage indication that indicates a sounding reference signal is to be used as an uplink tracking reference signal. In some cases, the usage indication is provided as an enumerated usage in a radio resource configuration parameter for a sounding reference signal resource set. In some cases, the sounding reference signal resource set having the enumerated usage indication for the uplink tracking reference signal is configured only for uplink tracking reference signal usage. In some cases, the usage indication is provided as a separate radio resource configuration parameter for a sounding reference signal resource set that has a different enumerated usage. In some cases, the different enumerated usage for the sounding reference signal includes one or more of a usage for antenna switching, codebook-based precoding measurements, non-codebook-based precoding measurements, or beam management.

The reference signal resource manager 1240 may provide configuration information that includes one or more of a time domain configuration, a frequency domain configuration, a spatial domain configuration, a power configuration, a periodicity configuration, an activation command configuration, a transmission configuration, or any combinations thereof, for the sounding reference signal resource set. In some cases, the time domain configuration provides at least two time domain resources for transmission of the first sounding reference signal within the sounding reference signal resource set. In some cases, the time domain configuration provides at least two sounding reference signal resource sets in two or more consecutive uplink slots. In some cases, the time domain configuration provides at least two time domain resources for transmission of the first sounding reference signal with a two or a four symbol time domain gap, the time domain configuration provides separate configurations for a low-band frequency range and a high-band frequency range, or any combinations thereof. In some cases, the frequency domain configuration indicates that a same fixed subcarrier comb pattern is used across a set of time domain resources for transmitting the first sounding reference signal. In some cases, the periodicity configuration indicates a fixed periodicity for a set of transmissions of the first sounding reference signal. In some cases, the set of transmissions of the first sounding reference signal are configured with a same periodicity, a same frequency bandwidth, and a same set of subcarrier locations.

The reference signal port manager 1245 may identify a spatial domain configuration indicates that the first sounding reference signal is transmitted using a single antenna port. The reference signal power manager 1250 may identify a power configuration indicates that the first sounding reference signal is transmitted at a same transmit power across all sounding reference signal resources of the sounding reference signal resource set.

The TRS activation manager 1255 may activate, deactivate, or trigger an uplink TRS. In some cases, the set of transmissions of the first sounding reference signal are activated by a MAC-CE. In some cases, the first sounding reference signal is transmitted aperiodically in response to a trigger received at the UE. In some cases, the trigger is received in one or more of a DCI communication for the UE or in a group common DCI for a set of UEs. In some cases, the activation command configuration provides an activation, deactivation, or triggering of the sounding reference signal resource set based on a sounding reference signal activation command.

FIG. 13 shows a diagram of a system 1300 including a device 1305 that supports uplink tracking reference signal techniques in wireless communications in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may transmit, to a UE, control information that provides an indication that a first uplink reference signal is to be transmitted from the UE to provide one or more of frequency tracking or time tracking for uplink transmissions between the UE and one or more transmission-reception points, monitor, based on the indication, for the first uplink reference signal, and calculate one or more of a frequency shift or a time shift associated with uplink transmissions from the UE based on the first uplink reference signal.

The communications manager 1310 may also transmit, to a UE, configuration information for a sounding reference signal resource set that configures an uplink sounding reference signal for uplink tracking of one or more of frequency shifts or time shifts associated with uplink transmissions between the UE and one or more transmission-reception points, monitor, based on the configuration information, for a first sounding reference signal, and calculate one or more of a frequency shift or a time shift associated with uplink transmissions from the UE based on the first sounding reference signal.

The communications manager 1310 may also receive, from a UE, an uplink tracking capability indication that signals one or more capabilities of the UE for using a sounding reference signal as an uplink tracking reference signal for one or more of frequency tracking or time tracking for uplink transmissions from the UE, transmit to the UE, responsive to the uplink tracking capability indication, configuration information for at least a first sounding reference signal resource set that configures a first uplink sounding reference signal for uplink tracking, and receive the first uplink sounding reference signal from the UE based on the configuration information.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting uplink tracking reference signal techniques in wireless communications).

The inter-station communications manager 1345 may manage communications with other base station 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

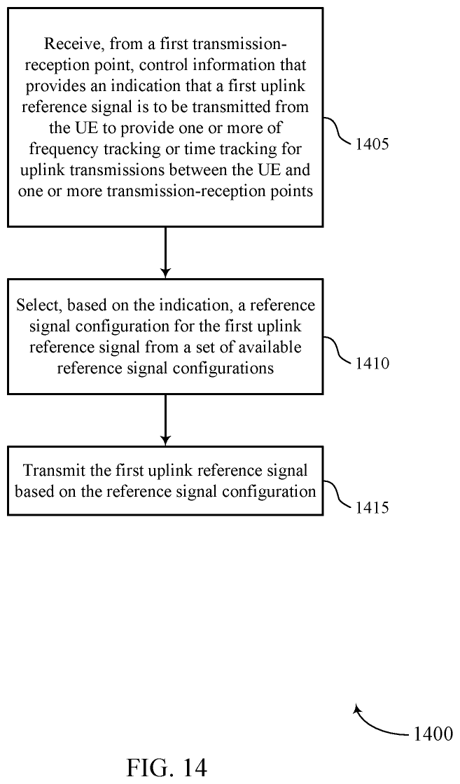

FIG. 14 shows a flowchart illustrating a method 1400 that supports uplink tracking reference signal techniques in wireless communications in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may receive, from a first transmission-reception point, control information that provides an indication that a first uplink reference signal is to be transmitted from the UE to provide one or more of frequency tracking or time tracking for uplink transmissions between the UE and one or more transmission-reception points. The operations of 1405 may be performed according to the methods described herein. In some examples, aspects of the operations of 1405 may be performed by a TRS manager as described with reference to FIGS. 6 through 9.

At 1410, the UE may select, based on the indication, a reference signal configuration for the first uplink reference signal from a set of available reference signal configurations. The operations of 1410 may be performed according to the methods described herein. In some examples, aspects of the operations of 1410 may be performed by a reference signal configuration manager as described with reference to FIGS. 6 through 9.

At 1415, the UE may transmit the first uplink reference signal based on the reference signal configuration. The operations of 1415 may be performed according to the methods described herein. In some examples, aspects of the operations of 1415 may be performed by an uplink transmission manager as described with reference to FIGS. 6 through 9.

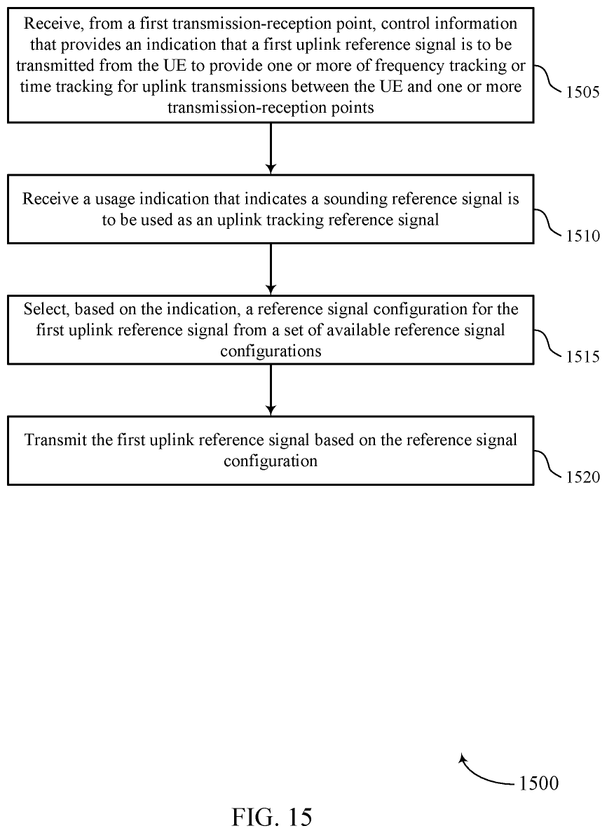

FIG. 15 shows a flowchart illustrating a method 1500 that supports uplink tracking reference signal techniques in wireless communications in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may receive, from a first transmission-reception point, control information that provides an indication that a first uplink reference signal is to be transmitted from the UE to provide one or more of frequency tracking or time tracking for uplink transmissions between the UE and one or more transmission-reception points. The operations of 1505 may be performed according to the methods described herein. In some examples, aspects of the operations of 1505 may be performed by a TRS manager as described with reference to FIGS. 6 through 9.

At 1510, the UE may receive a usage indication that indicates a sounding reference signal is to be used as an uplink tracking reference signal. The operations of 1510 may be performed according to the methods described herein. In some examples, aspects of the operations of 1510 may be performed by a SRS manager as described with reference to FIGS. 6 through 9. In some cases, the usage indication is provided as an enumerated usage in a radio resource configuration parameter for a sounding reference signal resource set. In some cases, the sounding reference signal resource set having the enumerated usage indication for the uplink tracking reference signal is configured only for uplink tracking reference signal usage. In some cases, the usage indication is provided as a separate radio resource configuration parameter for a sounding reference signal resource set that has a different enumerated usage. In some cases, the different enumerated usage for the sounding reference signal includes one or more of a usage for antenna switching, codebook-based precoding measurements, non-codebook-based precoding measurements, or beam management.

At 1515, the UE may select, based on the indication, a reference signal configuration for the first uplink reference signal from a set of available reference signal configurations. The operations of 1515 may be performed according to the methods described herein. In some examples, aspects of the operations of 1515 may be performed by a reference signal configuration manager as described with reference to FIGS. 6 through 9.

At 1520, the UE may transmit the first uplink reference signal based on the reference signal configuration. The operations of 1520 may be performed according to the methods described herein. In some examples, aspects of the operations of 1520 may be performed by an uplink transmission manager as described with reference to FIGS. 6 through 9.

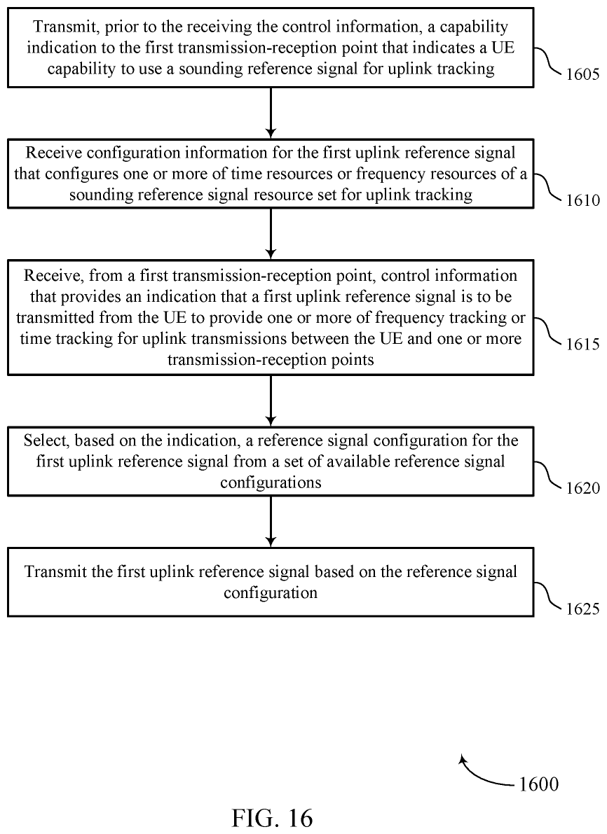

FIG. 16 shows a flowchart illustrating a method 1600 that supports uplink tracking reference signal techniques in wireless communications in accordance with aspects of the present disclosure. The operations of method 1600 may be implemented by a UE 115 or its components as described herein. For example, the operations of method 1600 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1605, the UE may transmit, prior to the receiving the control information, a capability indication to the first transmission-reception point that indicates a UE capability to use a sounding reference signal for uplink tracking. The operations of 1605 may be performed according to the methods described herein. In some examples, aspects of the operations of 1605 may be performed by a capability indication manager as described with reference to FIGS. 6 through 9.

At 1610, the UE may receive configuration information for the first uplink reference signal that configures one or more of time resources or frequency resources of a sounding reference signal resource set for uplink tracking. The operations of 1610 may be performed according to the methods described herein. In some examples, aspects of the operations of 1610 may be performed by a reference signal configuration manager as described with reference to FIGS. 6 through 9.

At 1615, the UE may receive, from a first transmission-reception point, control information that provides an indication that a first uplink reference signal is to be transmitted from the UE to provide one or more of frequency tracking or time tracking for uplink transmissions between the UE and one or more transmission-reception points. The operations of 1615 may be performed according to the methods described herein. In some examples, aspects of the operations of 1615 may be performed by a TRS manager as described with reference to FIGS. 6 through 9.

At 1620, the UE may select, based on the indication, a reference signal configuration for the first uplink reference signal from a set of available reference signal configurations. The operations of 1620 may be performed according to the methods described herein. In some examples, aspects of the operations of 1620 may be performed by a reference signal configuration manager as described with reference to FIGS. 6 through 9.

At 1625, the UE may transmit the first uplink reference signal based on the reference signal configuration. The operations of 1625 may be performed according to the methods described herein. In some examples, aspects of the operations of 1625 may be performed by an uplink transmission manager as described with reference to FIGS. 6 through 9.

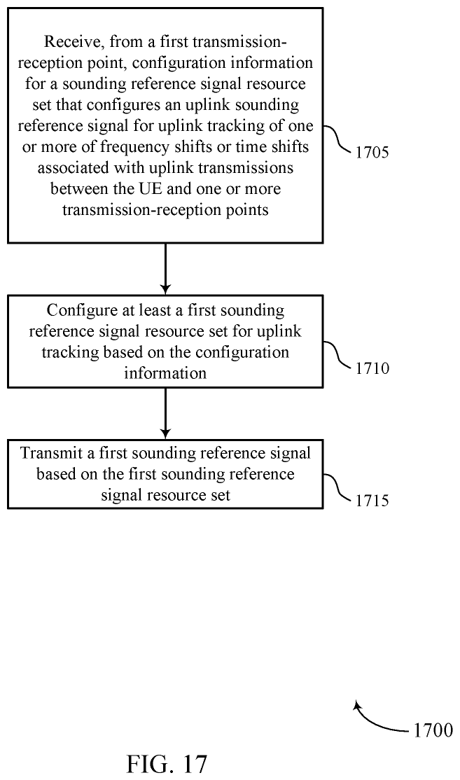

FIG. 17 shows a flowchart illustrating a method 1700 that supports uplink tracking reference signal techniques in wireless communications in accordance with aspects of the present disclosure. The operations of method 1700 may be implemented by a UE 115 or its components as described herein. For example, the operations of method 1700 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1705, the UE may receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points. The operations of 1705 may be performed according to the methods described herein. In some examples, aspects of the operations of 1705 may be performed by a reference signal configuration manager as described with reference to FIGS. 6 through 9.

At 1710, the UE may configure at least a first sounding reference signal resource set for uplink tracking based on the configuration information. The operations of 1710 may be performed according to the methods described herein. In some examples, aspects of the operations of 1710 may be performed by a TRS manager as described with reference to FIGS. 6 through 9.

At 1715, the UE may transmit a first sounding reference signal based on the first sounding reference signal resource set. The operations of 1715 may be performed according to the methods described herein. In some examples, aspects of the operations of 1715 may be performed by an uplink transmission manager as described with reference to FIGS. 6 through 9.

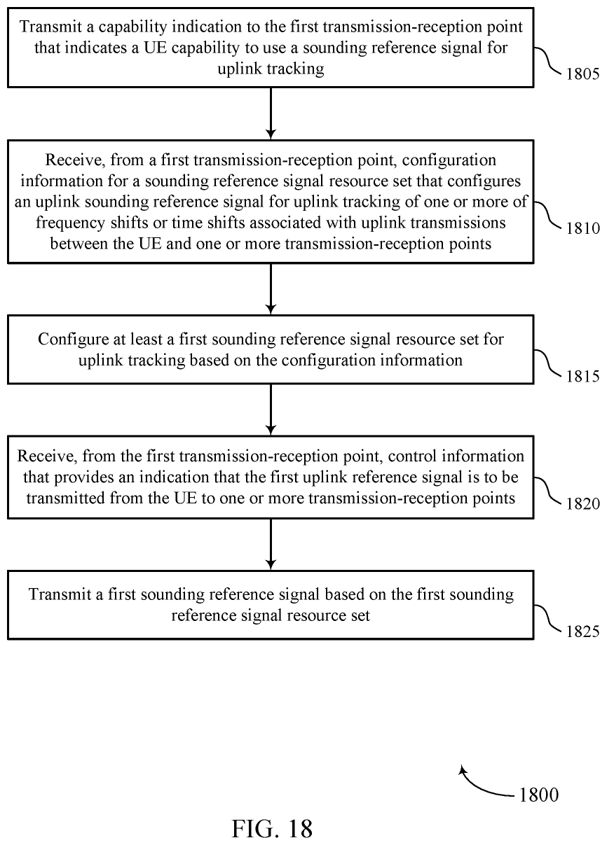

FIG. 18 shows a flowchart illustrating a method 1800 that supports uplink tracking reference signal techniques in wireless communications in accordance with aspects of the present disclosure. The operations of method 1800 may be implemented by a UE 115 or its components as described herein. For example, the operations of method 1800 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1805, the UE may transmit a capability indication to the first transmission-reception point that indicates a UE capability to use a sounding reference signal for uplink tracking. The operations of 1805 may be performed according to the methods described herein. In some examples, aspects of the operations of 1805 may be performed by a capability indication manager as described with reference to FIGS. 6 through 9.

At 1810, the UE may receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points. The operations of 1810 may be performed according to the methods described herein. In some examples, aspects of the operations of 1810 may be performed by a reference signal configuration manager as described with reference to FIGS. 6 through 9.

At 1815, the UE may configure at least a first sounding reference signal resource set for uplink tracking based on the configuration information. The operations of 1815 may be performed according to the methods described herein. In some examples, aspects of the operations of 1815 may be performed by a TRS manager as described with reference to FIGS. 6 through 9.

At 1820, the UE may receive, from the first transmission-reception point, control information that provides an indication that the first uplink reference signal is to be transmitted from the UE to one or more transmission-reception points. The operations of 1820 may be performed according to the methods described herein. In some examples, aspects of the operations of 1820 may be performed by a TRS manager as described with reference to FIGS. 6 through 9.

At 1825, the UE may transmit a first sounding reference signal based on the first sounding reference signal resource set. The operations of 1825 may be performed according to the methods described herein. In some examples, aspects of the operations of 1825 may be performed by an uplink transmission manager as described with reference to FIGS. 6 through 9.

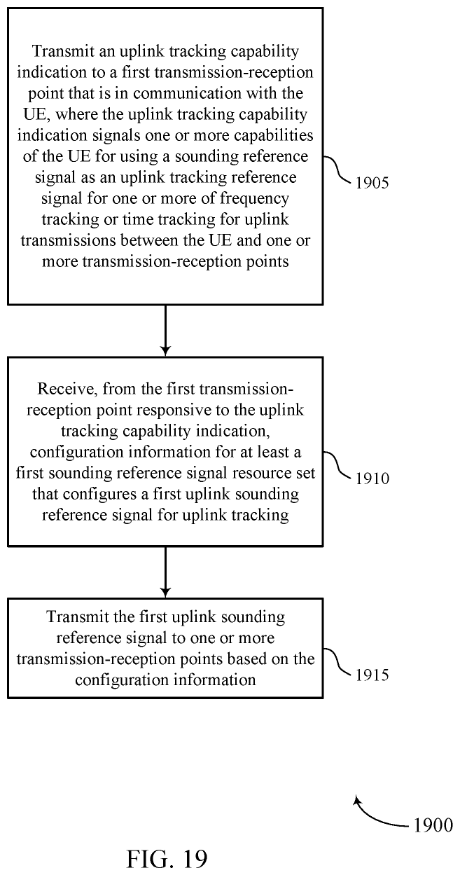

FIG. 19 shows a flowchart illustrating a method 1900 that supports uplink tracking reference signal techniques in wireless communications in accordance with aspects of the present disclosure. The operations of method 1900 may be implemented by a UE 115 or its components as described herein. For example, the operations of method 1900 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1905, the UE may transmit an uplink tracking capability indication to a first transmission-reception point that is in communication with the UE, where the uplink tracking capability indication signals one or more capabilities of the UE for using a sounding reference signal as an uplink tracking reference signal for one or more of frequency tracking or time tracking for uplink transmissions between the UE and one or more transmission-reception points. The operations of 1905 may be performed according to the methods described herein. In some examples, aspects of the operations of 1905 may be performed by a capability indication manager as described with reference to FIGS. 6 through 9.

At 1910, the UE may receive, from the first transmission-reception point responsive to the uplink tracking capability indication, configuration information for at least a first sounding reference signal resource set that configures a first uplink sounding reference signal for uplink tracking. The operations of 1910 may be performed according to the methods described herein. In some examples, aspects of the operations of 1910 may be performed by a reference signal configuration manager as described with reference to FIGS. 6 through 9.

At 1915, the UE may transmit the first uplink sounding reference signal to one or more transmission-reception points based on the configuration information. The operations of 1915 may be performed according to the methods described herein. In some examples, aspects of the operations of 1915 may be performed by an uplink transmission manager as described with reference to FIGS. 6 through 9.

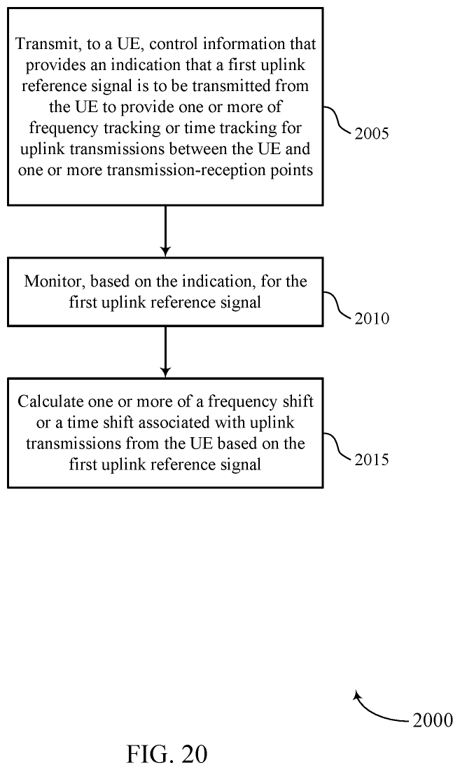

FIG. 20 shows a flowchart illustrating a method 2000 that supports uplink tracking reference signal techniques in wireless communications in accordance with aspects of the present disclosure. The operations of method 2000 may be implemented by a base station 105 or its components as described herein. For example, the operations of method 2000 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 2005, the base station may transmit, to a UE, control information that provides an indication that a first uplink reference signal is to be transmitted from the UE to provide one or more of frequency tracking or time tracking for uplink transmissions between the UE and one or more transmission-reception points. The operations of 2005 may be performed according to the methods described herein. In some examples, aspects of the operations of 2005 may be performed by a TRS manager as described with reference to FIGS. 10 through 13.

At 2010, the base station may monitor, based on the indication, for the first uplink reference signal. The operations of 2010 may be performed according to the methods described herein. In some examples, aspects of the operations of 2010 may be performed by an uplink transmission manager as described with reference to FIGS. 10 through 13.

At 2015, the base station may calculate one or more of a frequency shift or a time shift associated with uplink transmissions from the UE based on the first uplink reference signal. The operations of 2015 may be performed according to the methods described herein. In some examples, aspects of the operations of 2015 may be performed by a tracking manager as described with reference to FIGS. 10 through 13.

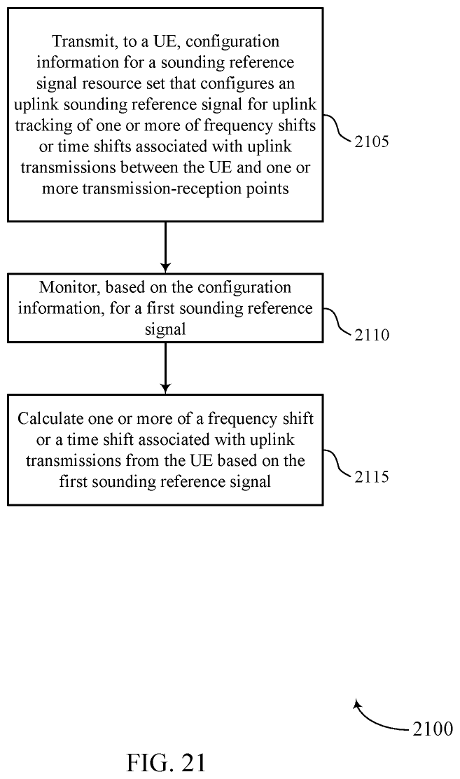

FIG. 21 shows a flowchart illustrating a method 2100 that supports uplink tracking reference signal techniques in wireless communications in accordance with aspects of the present disclosure. The operations of method 2100 may be implemented by a base station 105 or its components as described herein. For example, the operations of method 2100 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 2105, the base station may transmit, to a UE, configuration information for a sounding reference signal resource set that configures an uplink sounding reference signal for uplink tracking of one or more of frequency shifts or time shifts associated with uplink transmissions between the UE and one or more transmission-reception points. The operations of 2105 may be performed according to the methods described herein. In some examples, aspects of the operations of 2105 may be performed by a reference signal configuration manager as described with reference to FIGS. 10 through 13.

At 2110, the base station may monitor, based on the configuration information, for a first sounding reference signal. The operations of 2110 may be performed according to the methods described herein. In some examples, aspects of the operations of 2110 may be performed by an uplink transmission manager as described with reference to FIGS. 10 through 13.

At 2115, the base station may calculate one or more of a frequency shift or a time shift associated with uplink transmissions from the UE based on the first sounding reference signal. The operations of 2115 may be performed according to the methods described herein. In some examples, aspects of the operations of 2115 may be performed by a tracking manager as described with reference to FIGS. 10 through 13.

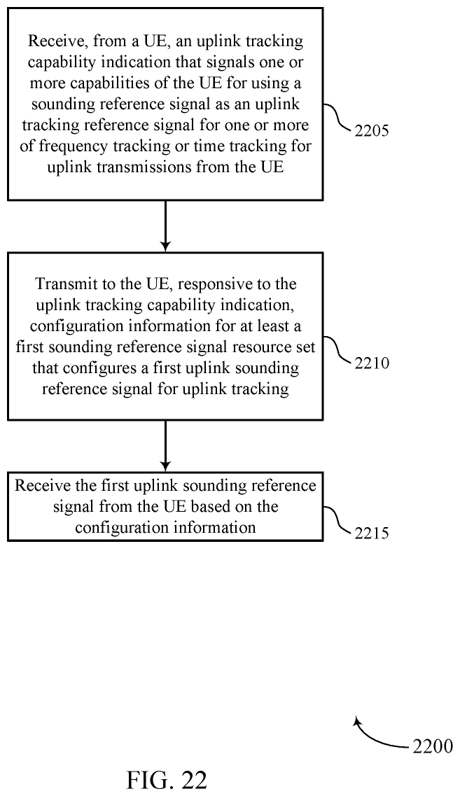

FIG. 22 shows a flowchart illustrating a method 2200 that supports uplink tracking reference signal techniques in wireless communications in accordance with aspects of the present disclosure. The operations of method 2200 may be implemented by a base station 105 or its components as described herein. For example, the operations of method 2200 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 2205, the base station may receive, from a UE, an uplink tracking capability indication that signals one or more capabilities of the UE for using a sounding reference signal as an uplink tracking reference signal for one or more of frequency tracking or time tracking for uplink transmissions from the UE. The operations of 2205 may be performed according to the methods described herein. In some examples, aspects of the operations of 2205 may be performed by a capability indication manager as described with reference to FIGS. 10 through 13.

At 2210, the base station may transmit to the UE, responsive to the uplink tracking capability indication, configuration information for at least a first sounding reference signal resource set that configures a first uplink sounding reference signal for uplink tracking. The operations of 2210 may be performed according to the methods described herein. In some examples, aspects of the operations of 2210 may be performed by a reference signal configuration manager as described with reference to FIGS. 10 through 13.

At 2215, the base station may receive the first uplink sounding reference signal from the UE based on the configuration information. The operations of 2215 may be performed according to the methods described herein. In some examples, aspects of the operations of 2215 may be performed by an uplink transmission manager as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-di), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
receiving, from a first transmission-reception point, control information that provides an indication that a first uplink reference signal is to be transmitted from the UE to provide one or more of frequency tracking or time tracking for uplink transmissions between the UE and one or more transmission-reception points;
selecting, based at least in part on the indication, a reference signal configuration for the first uplink reference signal from a plurality of available reference signal configurations; and
transmitting the first uplink reference signal based at least in part on the reference signal configuration.

2. The method of claim 1, wherein the receiving the control information further comprises:
receiving a usage indication that indicates a sounding reference signal is to be used as an uplink tracking reference signal.

3. The method of claim 2, wherein the usage indication is provided as an enumerated usage in a radio resource configuration parameter for a sounding reference signal resource set.

4. The method of claim 3, wherein the sounding reference signal resource set having the enumerated usage indication for the uplink tracking reference signal is configured only for uplink tracking reference signal usage.

5. The method of claim 2, wherein the usage indication is provided as a separate radio resource configuration parameter for a sounding reference signal resource set that has a different enumerated usage.

6. The method of claim 5, wherein the different enumerated usage for the sounding reference signal includes one or more of a usage for antenna switching, codebook-based precoding measurements, non-codebook-based precoding measurements, or beam management.

7. The method of claim 1, further comprising:
receiving configuration information for the first uplink reference signal that configures one or more of time resources or frequency resources of a sounding reference signal resource set for uplink tracking.

8. The method of claim 1, further comprising:
transmitting, prior to the receiving the control information, a capability indication to the first transmission-reception point that indicates a UE capability to use a sounding reference signal for uplink tracking.

9. A method for wireless communication at a user equipment (UE), comprising:
receiving, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points;
configuring at least a first sounding reference signal resource set for uplink tracking based at least in part on the configuration information; and
transmitting a first sounding reference signal based at least in part on the first sounding reference signal resource set.

10. The method of claim 9, wherein the configuration information includes one or more of a time domain configuration, a frequency domain configuration, a spatial domain configuration, a power configuration, a periodicity configuration, an activation command configuration, a transmission configuration, or any combinations thereof, for the first sounding reference signal resource set.

11. The method of claim 10, wherein the time domain configuration provides at least two time domain resources for transmission of the first sounding reference signal within the first sounding reference signal resource set, or provides at least two sounding reference signal resource sets in two or more consecutive uplink slots.

12. (canceled)

12. The method of claim 10, wherein the time domain configuration provides at least two time domain resources for transmission of the first sounding reference signal with a two or a four symbol time domain gap, the time domain configuration provides separate configurations for a low-band frequency range and a high-band frequency range, or any combinations thereof.

13. The method of claim 10, wherein the frequency domain configuration indicates that a same fixed subcarrier comb pattern is used across a plurality of time domain resources for transmitting the first sounding reference signal.

14. The method of claim 10, wherein the spatial domain configuration indicates that the first sounding reference signal is transmitted using a single antenna port.

15. The method of claim 10, wherein the power configuration indicates that the first sounding reference signal is transmitted at a same transmit power across all sounding reference signal resources of the first sounding reference signal resource set.

16. The method of claim 10, wherein the periodicity configuration indicates a fixed periodicity for a plurality of transmissions of the first sounding reference signal.

18.-19. (canceled)

17. The method of claim 10, wherein the first sounding reference signal is transmitted aperiodically in response to a trigger received at the UE.

21. (canceled)

18. The method of claim 10, wherein the activation command configuration provides an activation, deactivation, or triggering of the first sounding reference signal resource set based on a sounding reference signal activation command.

23. (canceled)

19. The method of claim 9, further comprising:
receiving, from the first transmission-reception point, control information that provides an indication that the first uplink reference signal is to be transmitted from the UE to one or more transmission-reception points.

20. The method of claim 9, further comprising:
transmitting, prior to the receiving the configuration information, a capability indication to the first transmission-reception point that indicates a UE capability to use a sounding reference signal for uplink tracking.

21. A method for wireless communication at a user equipment (UE), comprising:
transmitting an uplink tracking capability indication to a first transmission-reception point that is in communication with the UE, wherein the uplink tracking capability indication signals one or more capabilities of the UE for using a sounding reference signal as an uplink tracking reference signal for one or more of frequency tracking or time tracking for uplink transmissions between the UE and one or more transmission-reception points;
receiving, from the first transmission-reception point responsive to the uplink tracking capability indication, configuration information for at least a first sounding reference signal resource set that configures a first uplink sounding reference signal for uplink tracking; and
transmitting the first uplink sounding reference signal to one or more transmission-reception points based at least in part on the configuration information.

22. The method of claim 21, wherein the uplink tracking capability indication is transmitted to the first transmission-reception point in radio resource control signaling during a connection establishment procedure for the UE.

23. The method of claim 21, further comprising:
receiving, from the first transmission-reception point, control information that provides an indication that the first uplink reference signal is to be transmitted from the UE to one or more transmission-reception points.

24. The method of claim 21, further comprising:
receiving configuration information for the first uplink reference signal that configures one or more of time resources or frequency resources of the first sounding reference signal resource set for uplink tracking.

30.-37. (canceled)

25. A method for wireless communication at a transmission-reception point, comprising:
transmitting, to a user equipment (UE), configuration information for a sounding reference signal resource set that configures an uplink sounding reference signal for uplink tracking of one or more of frequency shifts or time shifts associated with uplink transmissions between the UE and one or more transmission-reception points;
monitoring, based at least in part on the configuration information, for a first sounding reference signal; and
calculating one or more of a frequency shift or a time shift associated with uplink transmissions from the UE based at least in part on the first sounding reference signal.

26. The method of claim 25, wherein the configuration information includes one or more of a time domain configuration, a frequency domain configuration, a spatial domain configuration, a power configuration, a periodicity configuration, an activation command configuration, a transmission configuration, or any combinations thereof, for the sounding reference signal resource set.

27. The method of claim 26, wherein the time domain configuration provides at least two time domain resources for transmission of the first sounding reference signal within the sounding reference signal resource set.

41.-52. (canceled)

28. The method of claim 25, further comprising:
transmitting, to the UE, control information that provides an indication that the first uplink reference signal is to be transmitted from the UE to one or more transmission-reception points.

29. The method of claim 25, further comprising:
receiving, prior to the transmitting the configuration information, a capability indication from the UE that indicates a capability to use a sounding reference signal for uplink tracking.

55.-64. (canceled)

30. An apparatus for wireless communication at a user equipment (UE), comprising:
a processor,
memory coupled with the processor; and
instructions stored in the memory and executable by the processor to cause the apparatus to:
receive, from a first transmission-reception point, configuration information for a sounding reference signal resource set that configures an uplink sounding reference signal for uplink tracking of one or more of frequency shifts or time shifts associated with uplink transmissions between the UE and one or more transmission-reception points;
configure at least a first sounding reference signal resource set for uplink tracking based at least in part on the configuration information; and
transmit a first sounding reference signal based at least in part on the first sounding reference signal resource set.

31. The apparatus of claim 30, wherein the configuration information includes one or more of a time domain configuration, a frequency domain configuration, a spatial domain configuration, a power configuration, a periodicity configuration, an activation command configuration, a transmission configuration, or any combinations thereof, for the first sounding reference signal resource set.

32. The apparatus of claim 31, wherein the time domain configuration provides at least two time domain resources for transmission of the first sounding reference signal within the first sounding reference signal resource set.

33. The apparatus of claim 31, wherein the time domain configuration provides at least two sounding reference signal resource sets in two or more consecutive uplink slots.

34. The apparatus of claim 31, wherein the time domain configuration provides at least two time domain resources for transmission of the first sounding reference signal with a two or a four symbol time domain gap, the time domain configuration provides separate configurations for a low-band frequency range and a high-band frequency range, or any combinations thereof.

70.-77. (canceled)

35. The apparatus of claim 30, wherein the instructions are further executable by the processor to cause the apparatus to:
transmit, prior to the receiving the configuration information, a capability indication to the first transmission-reception point that indicates a UE capability to use a sounding reference signal for uplink tracking.

79.-116. (canceled)
